(19) United States
(12) Patent Application Publication
(10) Pub. No.: US 2004/0187704 A1
(43) Pub. Date: Sep. 30, 2004

(54) Multi-purpose steamer/smoker and grilling devices

(76) Inventors: Andrew Citrynell, Carbondale, CO (US); Kimberly Ann Miller, Carbondale, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/727,878

(22) Filed: Dec. 3, 2003

Related U.S. Application Data
(63) Continuation-in-part of application No. 10/400,209, filed on Mar. 26, 2003.

(51) Int. Cl. A47J 37/10

(52) U.S. Cl. 99/422; 99/445

(57) ABSTRACT

A grilling system comprises a grill base that is adapted to be heated. The grill base has a top end, a bottom end, and an open interior that is adapted to hold a heatable substance that produces smoke or liquid vapors when heated. A manifold is coupled to the grill base so as to be positioned above the heatable substance. A grill member is positioned above the manifold. The grill member comprises at least one grill surface having a plurality of holes. The grill surface is configured to receive a grillable substance, whereby smoke or liquid vapors rising from the grill base pass through the manifold and then through the holes in the grill surface.

### CROSS REFERENCES TO RELATED APPLICATIONS

This application is a continuation in part application and claims the benefit of copending U.S. application Ser. No. 10/400,209, filed Mar. 26, 2003 by Citrynell et al., the complete disclosure of which is herein incorporated by reference.

### BACKGROUND OF THE INVENTION

This invention relates generally to the field of cooking, and in particular to the grilling of grillable substances, such as meats, fish, poultry, vegetables, vegetable burgers and the like. More specifically, the invention relates to the cooking of such substances using a grill while simultaneously steaming and/or smoking such substances.

Grilling is a favorite pastime for many throughout the world. Perhaps the most common types of grills are traditional charcoal-type grills, open flame grills and grills using heating elements. With charcoal-type grills, a pile of charcoal pieces is ignited in a grill base. Once the charcoals turn into coals, a grill is placed over the coals and the item to be grilled is placed onto the grill. Open flame grills typically use a flammable gas, such as propane or natural gas, to produce an open flame. A grill is placed over the open flame and the item to be cooked is placed onto the grill. Grills that utilize heating elements can take a variety of forms including solid grill surfaces that are directly heated with electrical elements, open flames or the like.

With each of these systems, it is difficult to conveniently flavor the food during grilling. Further, the grilling process tends to dry out the food, especially meats that are well cooked.

### BRIEF SUMMARY OF THE INVENTION

The invention provides grilling systems and methods that permit essentially any type of grillable substance to be grilled while simultaneously providing smoke and/or steam to the grillable substance. Further, greases or other liquids may be drained from the grillable substance. These features may serve to flavor and/or moisten the food, even when well cooked. In this way, the grilled food may better tasting, moister and healthier.

In one embodiment, a grilling system comprises a grill base that is adapted to be heated, such as with a conventional type of grill. The grill base has a top end, a bottom end, and an open interior that is adapted to hold a heatable substance that produces smoke or liquid vapors when heated. The top end can define one or more openings, thereby exposing the open interior. A manifold is coupled to the grill base so as to be positioned above the heatable substance. The manifold is used to evenly distribute smoke and/or liquid vapors from the base member to the food being cooked.

A grill member is also positioned above the manifold. The grill member comprises at least one grill surface having a plurality of holes over which a grillable substance may be placed. In this way, when the grill base is heated, smoke or liquid vapors rise from the grill base and pass through the manifold where they pass through the holes in the grill surface. Hence, the grillable substance is grilled by virtue of being in contact with the grill surface that in turn is heated by heat transferred from the base, to the manifold and to the grill member. At the same time, the smoke and/or vapors contact the grillable substances through the holes in the grill surface to cook, flavor and/or moisten the grillable substance.

The grill base may be constructed to have a wide variety of shapes, such as rectangular, square, pyramidal, circular, oblong, and the like. In one particular aspect, the grill base may have an open bottom end to reduce manufacturing costs and provide easy access into the interior.

The holes in the grill surface can have a variety of cross-sectional profiles, including circular, square, oblong, octagonal and the like. In certain embodiments, the holes have a diameter of about one-sixteenth inch to about one-half inches, and in other embodiments, the conduits have a diameter of about three-thirtysecondths inch to about three-sixteenths inch.

Optionally, the system may also include an insert that is configured to fit within the interior of the grill base. Conveniently, the insert may be used to hold the heatable substance, although in some cases, the heatable substance may be held directly within the interior. Examples of heatable fluids that may be placed into the insert include wine, beer, soda pop, liquid spices, flavored fluids, and the like. Heatable substances that may be placed into the interior include moist wood chips and other substances that produce smoke when heated. The insert may also have a wide variety of shapes including rectangular, square, circular, oval, triangular and the like. When the base has an open bottom end, the insert may easily be inserted into the base through the bottom end. Further, the insert may rest directly upon the grill to increase the amount of heat transfer.

In one aspect, the grill base comprises a thermally conductive material, such as stainless steel, and the insert comprises a thermally conductive material, ceramic or other material that may be heated to grill temperatures. Also, the manifold may comprise a thermally conductive material, and the grill surface comprises a grill material. The use of such materials facilitates heat transfer up to the grill surface.

In another aspect, the grill member comprises a plurality of grill surfaces that each include a plurality of holes that are in fluid communication with the manifold. The grill member also includes a plurality of downwardly angled fluid removal channels interleaved between the grill surfaces. In this way, greases or other liquids may drain from the grill member and down into the grill. In some embodiments, the grill member may include a fluid collection channel about its outer edge. The collection channel collects the fluids that drain from the fluid removal channels. The collection channel may include one or more drains to permit the fluids to drain into the manifold, rather than running down the outside of the base. The grill member may also include one or more handles to permit the grill member to be easily lifted from the manifold.

In one particular aspect, the manifold comprises a top platform that is removably coupled to the top of the grill base, a bottom platform that is removably coupled to the grill member, and a plurality of conduits extending between the top platform and the bottom platform. Conveniently, the top platform may include a male connector, and the grill base may include a female connector that is matable within the male connector to permit the two parts to be easily separated. Similarly, the grill member may include a male connector, and the bottom platform may include a female connector that is matable within the male connector. The conduits can have a variety of cross-sectional profiles, including circular, square, oblong, octagonal and the like. In certain embodiments, the conduits have a diameter of about one-half inch to about two inches, and in other embodiments, the conduits have a diameter of about three-quarters inch to about one and one-quarter inch.

In an alternative arrangement, the manifold may comprise a plurality of conduits that extend directly from the base and are also coupled to a platform. In turn, the platform may include a ledge or lip for holding the grill member. In this way, the grill member may be placed onto the platform when grilling and then removed for easy cleaning.

In accordance with some embodiments, the grill member maybe positioned above the grill base and removably coupled thereto, such that smoke or liquid vapors rising from the grill base pass through the holes in the grill surfaces. In some cases, the grill base can comprise a rotational coupling apparatus and the grill member can comprise a corresponding rotational coupling apparatus. Hence, when the grill member is coupled to the grill base, the grill member can be rotated about an axis defined approximately by the rotational coupling apparatus of the grill base, thereby allowing access to the open interior of the grill base.

A removable lid may also be used to cover the grillable substance. The lid may have one or more handles and may rest on the grill member or the platform of the manifold. The lid helps trap any smoke or vapors passing up through the grill surface and also holds in heat to heat the grillable substance quicker.

The invention also provides an exemplary method for grilling a grillable substance. The method utilizes a grill base having a top end, a bottom end, and an open interior. A heatable substance is placed into the interior. A manifold is coupled to the grill base so as to be positioned above the heatable substance. A grill member is positioned above the manifold and comprises at least one grill surface having a plurality of holes. At least one grillable substance is placed onto the grill surface, and the grill base is heated to cause heat to be transferred to the grill surface to grill the grillable substance. Heating of the base also produces smoke or liquid vapors from the heatable substance. The smoke or liquid vapors rise from the grill base and pass through the manifold and then through the holes in the grill surface to cook, flavor and/or moisten the grillable substance.

To heat the base, it may be placed onto a barbecue grill or other heating element. Further, the heatable substance may comprise moist wood chips that are placed into the interior to produce the smoke. Alternatively, the heatable substance may comprise a liquid that may conveniently be poured into an insert that in turn is placed into the interior.

In another feature, the grill base may be removed from the manifold, the manifold may be removed from the grill member, and the grill base, the manifold and the grill member may be washed. For convenience of manufacture, all components may be welded together except for the grill member that may be removed for cleaning. As one example, the various components may be washed in a conventional dishwasher.

### BRIEF DESCRIPTION OF THE DRAWINGS

FIG. 1 is a front view of an embodiment of a grilling system according to the invention.

FIG. 2 is a front perspective view of the grilling system of FIG. 1.

FIG. 3 is a perspective view of a grill member of the grilling system of FIG. 1.

FIG. 4A is a more detailed view of a top platform of the grilling system of FIG. 1.

FIG. 4B is a detailed view of a female connector of a grill base for mating with the male connector of FIG. 4A.

FIG. 5 is a cut away, exploded front view of the top platform of FIG. 4A and the grill base of FIG. 4B.

FIG. 6 is a partially cut away perspective view of another embodiment of a grilling system according to the invention.

FIG. 7 is a more detailed view of a locking mechanism of the grilling system of FIG. 6.

FIG. 8A is a front view of a grilling system in accordance with various embodiments of the invention.

FIG. 8B is a side view of the grilling system of FIG. 8A.

FIG. 8C is a front perspective drawing of the grilling system of FIG. 8A.

FIG. 9 is a top view of a base that can be used with the grilling system of FIG. 8.

FIG. 10 is a perspective view of an insert that may be used to hold a substance to be heated in accordance with embodiments of the invention.

FIG. 11 is a perspective drawing of a top platform that can be used with the grilling system of FIG. 8.

FIG. 12A is an isometric drawing of a bottom platform that can be used with the grilling system of FIG. 8.

FIG. 12B is a bottom view of the bottom platform of FIG. 12B.

FIG. 13 is an isometric view of a grill member that can be used with the grilling system of FIG. 8.

FIG. 14 is an isometric view of a conduit that can be used with the grilling system of FIG. 8.

FIG. 15 is an isometric view of a grilling system in accordance with other embodiments of the invention.

FIG. 16A is an isometric view of a grill base that can be used with the grill system of FIG. 15.

FIG. 16B is a cutaway profile view of the grill base of FIG. 16A.

FIG. 17 illustrates a top platform that can be used with the grilling system of FIG. 15.

FIG. 18 is an isometric drawing of a manifold that can be used with the grill system of FIG. 15.

FIG. 19A is an isometric drawing of a grill member that can be used with the grill system of FIG. 15.

FIG. 19B is a top view of the grill member of FIG. 19A.

FIG. 19C is a sectional view of the grill member of FIG. 19A.

FIG. 20 is an isometric drawing of a grilling system in accordance with further embodiments of the invention.

FIG. 21 is an isometric drawing of a grill base that can be used with the grill system of FIG. 20.

FIG. 22 is an isometric drawing of an insert that can be used with the grill system of FIG. 20.

FIG. 23A is an isometric drawing of a grill member that can be used with the grill system of FIG. 20.

FIG. 23B is a top view of a grill member of FIG. 23A.

FIG. 23C is a sectional drawing of the grill member of FIG. 23B.

FIG. 23D is another top view of a grill member that can be used with the grill system of FIG. 20.

FIGS. 23E and 23F are sectional drawings of the grill member of FIG. 23B.

FIG. 24 is a perspective view of another embodiment of a grilling system according to the invention.

FIG. 25 is a front view of the grilling system of FIG. 24.

FIG. 26 is a side view of the grilling system of FIG. 24.

FIG. 27 is a top view of the grilling system of FIG. 24.

FIG. 28 is a bottom view of the grilling system of FIG. 24.

FIG. 29 is a perspective view of an insert of the grilling system of FIG. 24.

FIG. 30 is a perspective view of a base of the grilling system of FIG. 24.

FIG. 31 is a top view of the base of FIG. 30.

FIG. 32 is a perspective view of the base of FIG. 30 coupled to a manifold.

FIG. 33 is a perspective view of a grill member of the grilling system of FIG. 24.

FIG. 34 is a top view of the gill member of FIG. 33.

FIG. 35 is a front view of the grill member of FIG. 33.

FIG. 36 is an end view of the grill member of FIG. 33.

FIG. 37 is a perspective view of a cover of the grilling system of FIG. 24.

### DETAILED DESCRIPTION OF THE INVENTION

Described below are several exemplary embodiments of the invention. Certain of the embodiments share similar features and/or elements. In such cases, similar features/elements of certain embodiments will be designated by similar reference numerals (e.g., 10, 10′ and 10 ″). Moreover, although certain features are described, for ease of discussion, in relation to certain illustrated embodiments, those skilled in the art will appreciate, based on the disclosure herein, that various of the inventive features can be combined in accordance with many different embodiments of the invention. The illustrated embodiments below, therefore, are provided merely by way of example and should not be considered to limit the scope of the invention, which is defined only by the appended claims.

The invention provides grilling systems and techniques for grilling grillable substances. Such substances may include, for example, meats, poultry, fish, vegetables, fruits, vegetable burgers, and the like. The grillable substances are placed onto a grill surface that has a plurality of holes that permit rising smoke and/or steam to pass upwardly through the grill surface and into contact with the grillable substance. In this way, the grillable substance may be grilled while also being smoked, flavored and/or moistened. The grill surface may also include downwardly sloping channels that permit greases and other liquids to drain from the grill surface where they drip onto the grill. This in turn allows for healthier cooking.

The grilling systems may utilize a grill base that may be placed onto a grill or any other type of heat source, including any of the grill types discussed in the Background section. The grill base is constructed of a thermally conductive material, such as metal or stainless steel, to permit heat to transfer to the grill surface. Further, the grill base may be used to hold or enclose a heatable substance that in turn is used to produce the smoke and/or steam. Examples of such heatable substances include wines, beer, soda pop, flavored liquids, water, juices, spices, wood chips, and the like. When steam is produced, the steam helps to moisten the substance, even when cooked until it is well done (such as when cooking meat to eliminate bacteria and disease).

To distribute the smoke and/or steam as well as to transfer heat, the grilling systems may utilize a manifold that may be constructed of a heat conducting material, such as metal or stainless steel. A variety of connectors may be used to couple the manifold to the grill base and the grill surface in a removable manner. Examples of such connectors include, for example, mating male and female connectors, screws, latches, bolts, clips, snaps and the like. By making the components removable, the grilling system may easily be disassembled for cleaning. For example, the components may easily fit within a dishwasher. In some cases, the manifold may be permanently connected to the base, such as by using welds. Such a construction may serve to reduce the size of the grilling system and to reduce manufacturing costs. Typically, the grill member will be removable from the manifold to permit easy cleaning of the grill member.

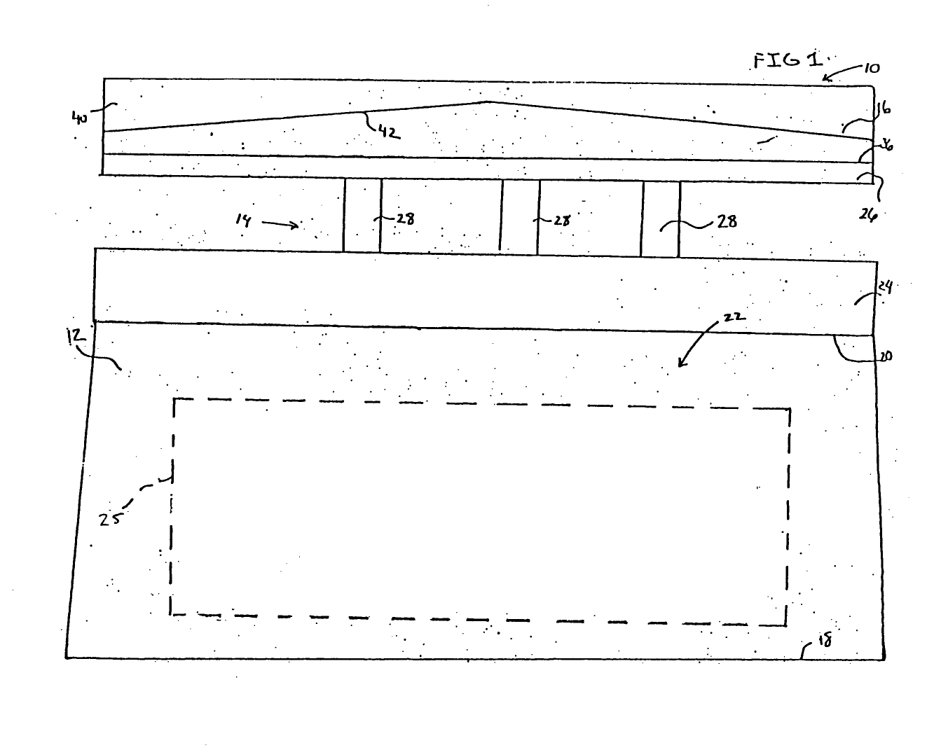

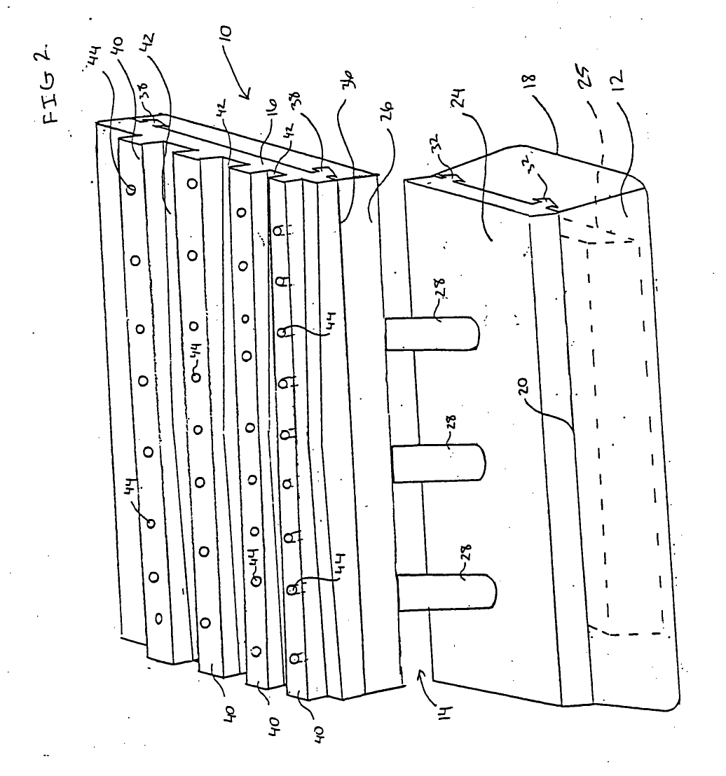

Referring now to FIGS. 1 and 2, one embodiment of a grilling system 10 will be described. Grilling system 10 comprises a grill base 12, a manifold 14 and a grill member 16. Grill base 12 has a bottom end 18, an open top end 20 and an interior 22 that is accessible from the open top end 20. Bottom end 18 is generally flat and is configured to rest on essentially any type of heated surface, such as a conventional grill, a heating element, or the like. Grill base 12 is preferably constructed of a thermally conductive material, such as metal, aluminum, or the like to efficiently transfer heat to interior 22 as well as to grill member 16.

The interior 22 of grill base 12 may be used to hold a substance that may be heated to produce smoke and/or liquid vapors that rise up into manifold 14. Such substances may comprise those that produce smoke, such as wood chips, as well as various types of liquids that produce steam when heated. The size of the interior may be varied depending on the substance used. Further, the size of bottom end 18 may vary depending on how much heat needs to be transferred, as well as on the size of grill member 16. Another advantage is that the grill base may be constructed to be small enough that it takes up only part of the grill upon which it rests. In this way, other food items may be grilled in the traditional manner on the grill while the grill is used to supply heat to the grill base 12. For example, the grill base could be small enough to take up only about ⅛ of the rest of the barbecue grill.

Optionally, an insert 25 may be held within interior 22 to hold a liquid that is to be heated. Insert 24 may comprise essentially any type of open vessel that is capable of holding a liquid and that can withstand the grilling temperatures. Examples of materials that may be used include ceramics, metals, composites, and the like. One advantage of using insert 25 is that it may easily be removed for cleaning.

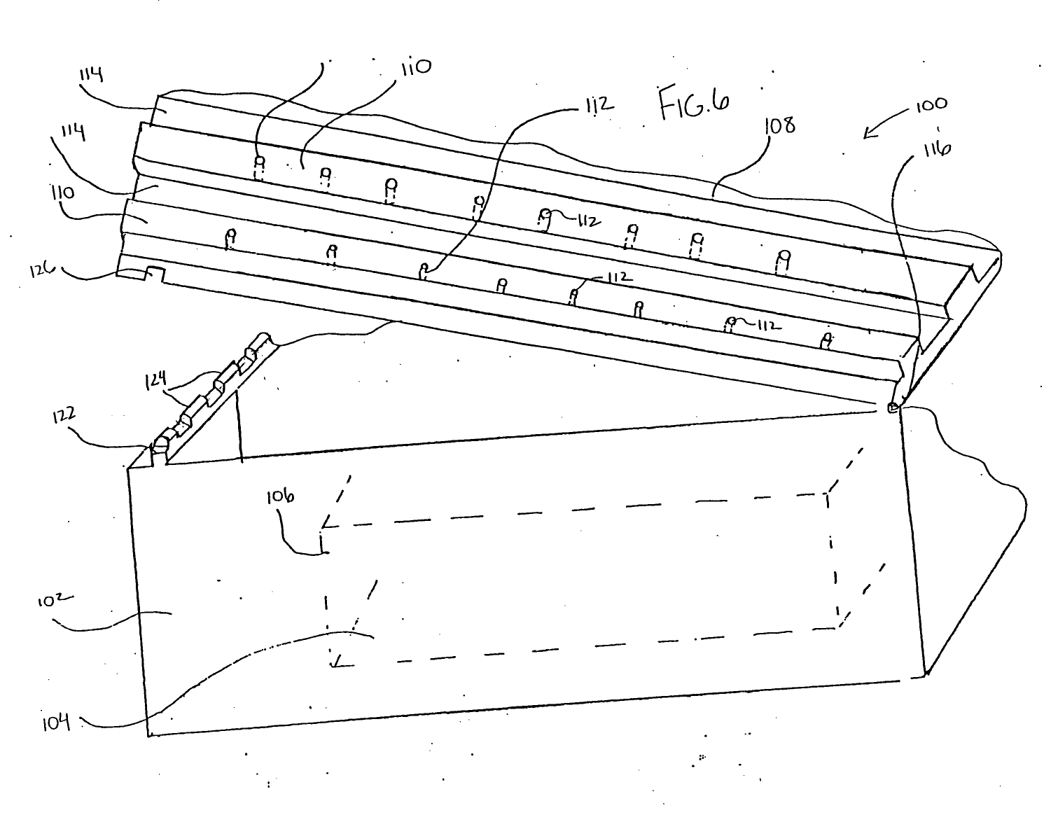

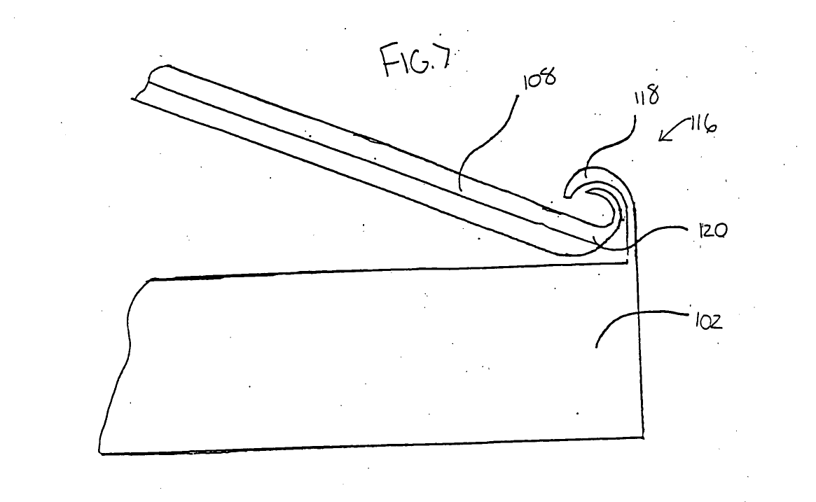

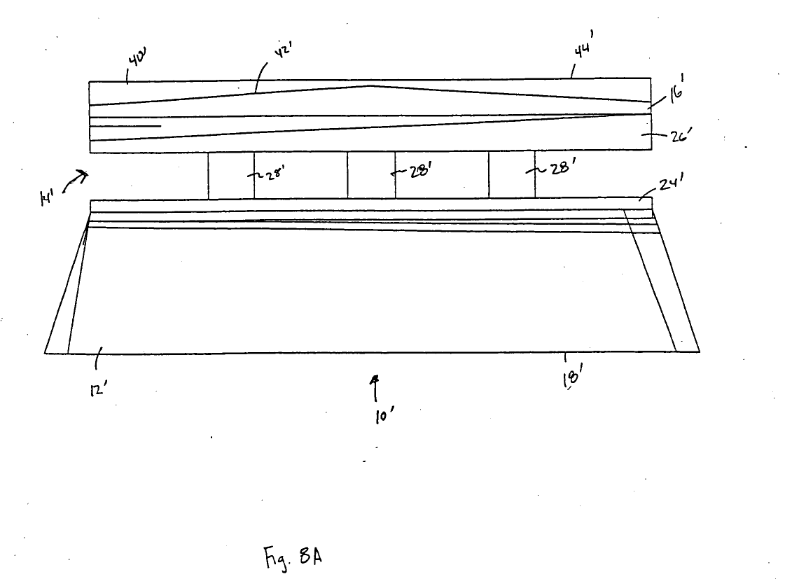

Manifold 14 is constructed of a top platform 24, a bottom platform 26 and a set of conduits 28 that fluidly connect top platform 24 to bottom platform 26. Top platform 24 is also shown in FIGS. 4A and 5 and comprises a thermally conductive plate having through holes that are aligned with conduits 28. In this way, when top platform 24 is coupled to grill base 12, the interior 22 is completely sealed except for the through holes. As such, when smoke or steam is produced within interior 22, it rises upward and exits the interior 22 through conduits 28.

As best illustrated in FIGS. 2, 4A, 4B and 5, top platform 24 includes a series of male connectors 30 that are configured to mate with corresponding slots 32 in grill base 12. Conveniently, male connectors 30 may be integrally formed with top platform 24 for ease of manufacture. Grill base 12 may also include various recesses 34 to permit the connectors 30 to be aligned with slots 32 (see FIG. 5). Once aligned, top platform 24 may be slid relative to grill base 12 to slide connectors 30 within slots 32 until the top platform 24 is aligned with grill base 12. Hence, to gain access to interior 22, such as when needing to place insert 24 and/or a substance into interior 22, top platform 24 may simply be slid until connectors 30 are aligned with recesses 34. Top platform 24 may then be lifted from grill base 12. Although shown with a slidable connection system, it will be appreciated that other types of connectors may be used as well including other interlocking designs, bolts, screws, clips, detents, and the like.

As shown, manifold 14 includes three conduits 28 having a diameter in the range from about ¼ inch to about 2 inches. In some embodiments, conduits 28 may have other shapes and corresponding cross sectional areas. The conduits may also have a height in the range from about ⅛ inch to about 6 inches. This configuration helps to insure that sufficient smoke and/or vapors reach the item being grilled. Conduits 28 also help to insure that the smoke or steam is evenly distributed to the entire grill surface so that all areas are evenly treated. By directing the smoke and/or steam up through conduits 28, the grill surface is spaced apart from the source of the smoke and/or steam to permit the smoke and/or steam to adequately diffuse so there is an even application to the items being grilled. In cases where smoking wood chips are used, the separation of the grill member 16 from interior 22 helps to insure than no soot from the smoking embers reaches grill member 16. Conduits 28 are preferably constructed of a thermally conductive material to permit heat from grill base 12 to be transferred to grill member 16. Although shown with three conduits 28, it will be appreciated that other numbers and/or sizes of conduits may be used as well. Further, in some cases, the conduits may be eliminated altogether so that the smoke and/or vapors pass directly to grill member 16.

Bottom platform 26 includes holes that are aligned with conduits 28. Further, bottom platform 26 includes four sides that form a cavity. When grill member 16 is coupled to bottom platform 26 it forms an open interior region that also functions as a plenum to distribute the rising smoke and/or vapors across a bottom end 36 of grill member 16. Bottom platform 26 may also be constructed of a thermally conductive material to transfer heat to grill member 16. Bottom platform 26 and grill member 16 may include an interlocking connection system similar to the system described in connection with grill base 12 and top platform 24 to permit the two components to be easily separated, such as for cleaning. For example, grill member 16 may include male connectors 38 that are similar to male connectors 30, and bottom platform 26 may include slots and recesses that are similar to slots 32 and recesses 34 in grill base 12. However, it will be appreciated that other types of connectors may be used as well.

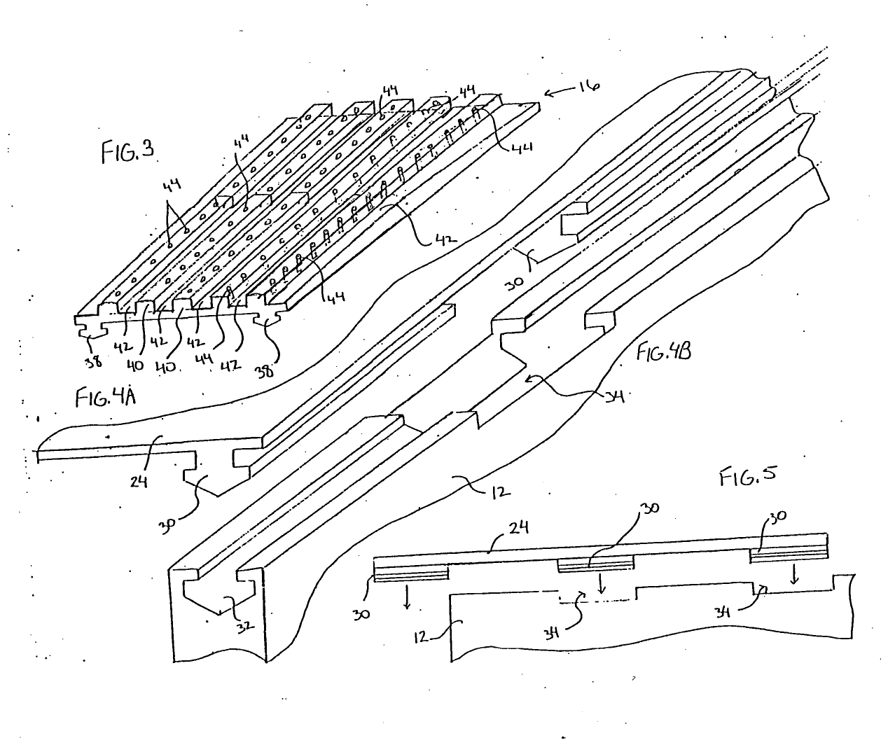

As best shown in FIGS. 2 and 3, grill member 16 may be constructed of a single piece of a grill material, such as metal, and may easily be removed from bottom platform 26. Grill member 16 includes a plurality of raised grill surfaces 40 that are generally parallel to and spaced apart from each other, although different configurations and orientations may be used as well. Grill surfaces 40 are designed to hold the substance being grilled. When grilling system 10 is placed onto a grill or otherwise heated, heat from base 12 is transferred through the device and up to grill surface which becomes hot enough to grill the substance resting on grill surfaces 40.

Positioned between grill surfaces 40 are a plurality of recessed channels 42. Channels 42 slope downward from an apex that is in the middle of grill member 16. In this way, greases or other liquids from the item being grilled flow down the channels and away from grill surfaces 40. When these liquids reach the edge of grill member 16, they drip off of grill member 16 and fall into the grill being used to supply the heat. Most grills include drip pans that may collect these liquids. Use of channels 42 thus helps to remove any grease or other undesirable substances from the item being grilled to produce a healthier food product.

Extending through grill surfaces 40 are a plurality of through holes 44 that completely pass through grill member 16. In this way, smoke and/or vapors rising up from interior 22 pass through conduits 28 and into the cavity defined by bottom platform 26. Here, the smoke and/or vapors are distributed across bottom 36 of grill member 16 and pass up through holes 44. As the smoke and/or vapors pass upwardly through holes 44, they come into contact with the items on grill surfaces 40. Depending on the type of smoke and/or steam, the items being grilled may be flavored, moistened and/or further cooked. Hence, the items being grilled may be smoked and/or steamed while simultaneously being grilled. Such a system may therefore be used to flavor the items without requiring them to continually be basted. Further, the items may be provided with a moist delicate flavor because they are moistened while being cooked, even if cooked to the point of being well done. As such, meats may be well cooked to eliminate bacteria or disease while still being moist and delicate.

The number and/or sizes of holes 44 may be varied depending upon a variety of factors, including the type of item being grilled, the substance used to produce the smoke and/or steam, the amount of flavoring required and the like. As one example, the holes may have a diameter in the range from about 1/16 inch to about ½ inch. If the holes have other shapes, the holes may have similar cross sectional areas. The holes are preferably large enough to prevent clogging while being small enough to keep a suitable grilling surface. The holes may be appropriately spaced apart to provide enough smoke or steam to the food while also providing an appropriate grilling surface. Another advantage of using channels 42 is that they assist to remove any liquids or greases so that holes 44 do not become clogged. Further, grill member 16 may easily be removed following grilling and placed into a dishwasher for cleaning in case any holes do become clogged.

One significant advantage of using the grill member is that is includes holes small enough to providing for smoking and/or steaming, but which are small enough so that food does not fall through them. In this way, small items, such as small vegetables, do not fall through the grilling surface where they could be lost or burned.

Referring now to FIGS. 6 and 7, another embodiment of a grill system 100 will be described. Grill system 100 is similar to the other embodiments, but does not use conduits to separate the cavity containing the heatable substance from the grill surface. More specifically, grill system 100 comprises a grill base 102 that is configured to be heated in a manner similar to the grill base of FIG. 1. Further, grill base 102 may have any of the shapes as previously described for the grill base of FIG. 1. Grill base 102 has an open interior 104 for holding a substance to be heated in a manner similar to that previously described. Further, the interior 104 may hold an insert 106 for holding a liquid to be heated in a manner similar to that described with other embodiments.

Coupled to grill base 102 is a grill member 108 that may be configured to function similar to the other grill members described herein. Grill member 108 includes a plurality of grill surfaces 110 that each include a plurality of through holes 112. Positioned between grill surfaces 110 are channels 114 to permit fluids to run off of grill member 108 in a manner similar to that previously described.

In use, grill member 108 is placed on top of grill base 102 so that smoke and/or steam from interior 104 passes upward through holes 112 to smoke, flavor and/or moisturize the substance being grilled. At the same time, heat from base 102 is transferred to grill surfaces 110 to grill the food in a manner similar to that previously described. As such, the components used to construct grill system 100 may be similar to the materials described with other embodiments.

Grill member 108 may be removably coupled to grill base 102 using a variety of techniques and connectors. Shown in FIG. 7 is one type of interlocking connector system 116 that may be used. Connector system 116 comprises a curved female locking mechanism 118 and a curved male locking mechanism 120. To connect the two components, grill member 108 is positioned in a generally vertical orientation and male locking mechanism 120 is inserted into female locking mechanism 118. Grill member 108 is then rotated downward until it rests on the top of grill base 102. The opposite movement may be used to separate the two components, such as for washing or placing substances into interior 104.

The opposite end of base 102 may include a male locking member 122 having a plurality of teeth 124. Locking member 124 is configured to mate with a female locking member 126 on grill member 108. When grill member 108 rests upon base 102, teeth 124 extend up into grill member 108 to contact the bottom of grill surfaces 110 while the bottom of channels 114 rest in the regions between teeth 124 to interlock the two components.

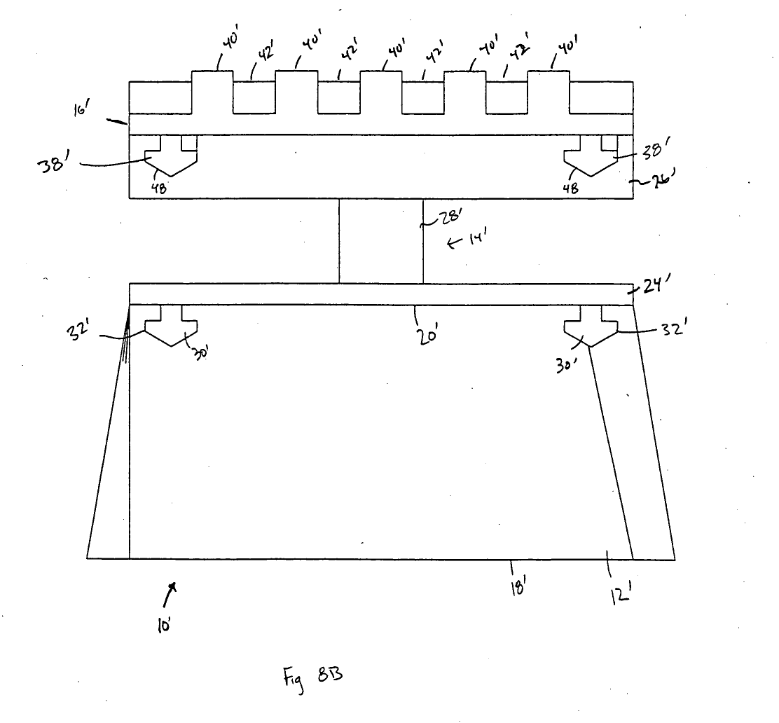

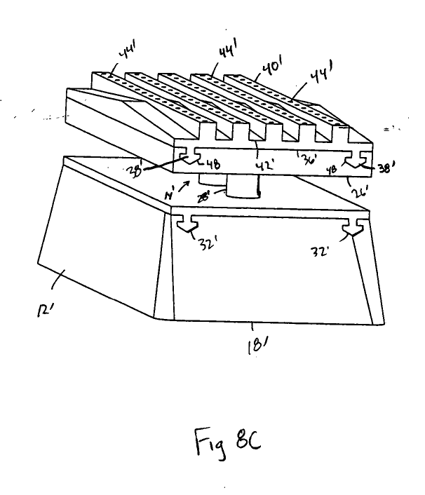

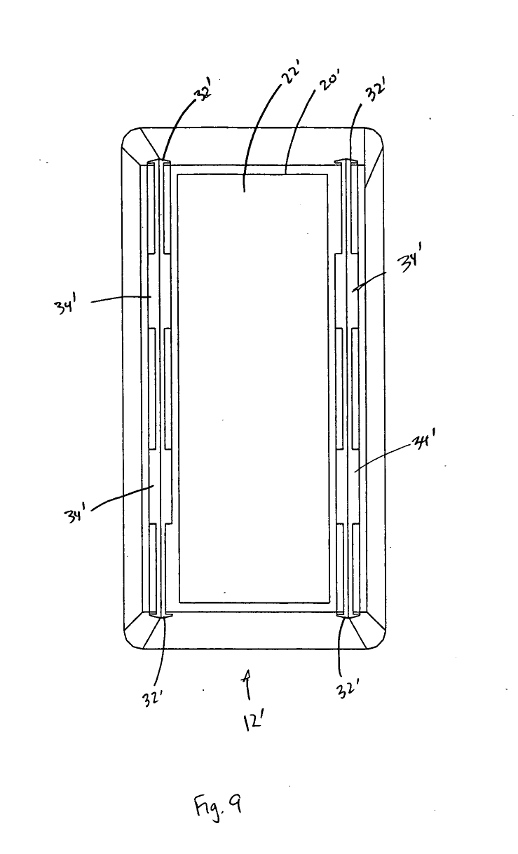

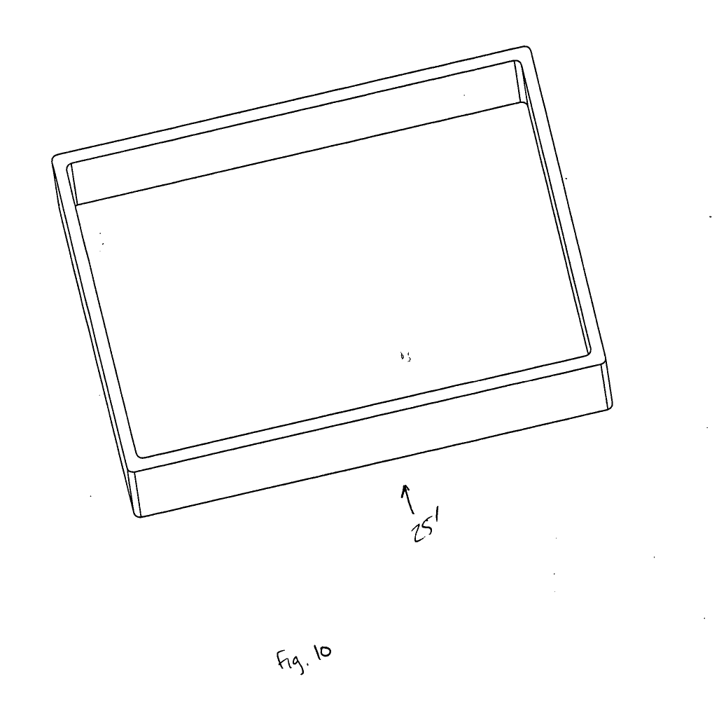

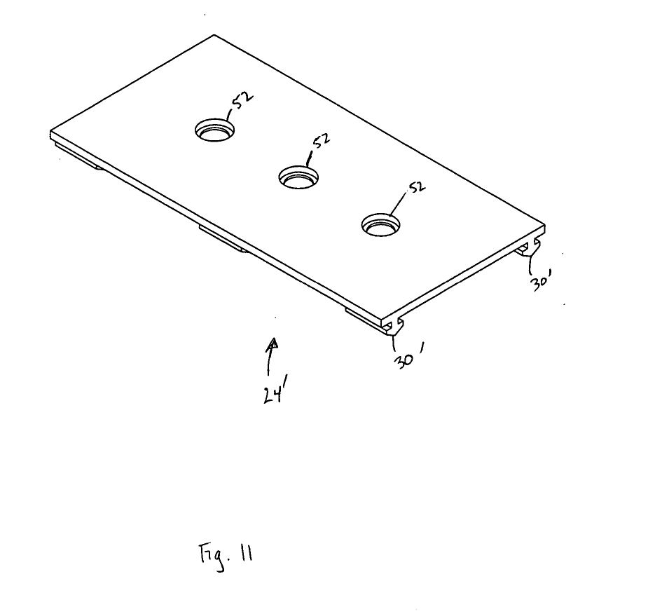

FIGS. 8-14 illustrate a grilling system 10′ in accordance with other embodiments of the invention. The grilling system 10′ includes a base 12′, a manifold 14′, and a grill member 16′. As discussed above, the grill base 12′ can include a flat bottom portion 18′ which can be placed on a heated surface in order, for instance, to heat the grill system 10′, including the grill base 12′ and/or the grill 16′. The manifold 14′ can include a top platform 24′, a bottom platform 26′ and one or more conduits 28′ therebetween. The manifold 14′, and in particular, the top platform 24′, can have a plurality of male connectors 30′ that can fit into female slots 32′, allowing for secure attachment of the top platform 24′ to the grill base 12′. Similarly, the grill member 16′ can have male connectors 38′, which can be mated to female connectors 48′ to provide a secure connection between the grill member 16′ and the manifold 14′, and in particular to the bottom platform 26′.

The grill member 16′ can have one or more grilling surfaces 40′ as well as one or more recessed channels 42′, which can, in some embodiments, slope downward from an apex located at or near the center of grill member 16′. Alternatively, the apex of the channels 42′ can be at locations other than the center of the grill member 16′, for instance on one end or the other of the grill member 16′ Each of the grill surfaces 40′ can have a plurality of through holes 44′ passing through grill member 16′. As noted above, the through holes 44′ can have any of a variety of cross-sectional areas and/or profiles, in accordance with various embodiments of the invention. In some embodiments, for example, the through holes 44′ can be between 1/16 inch and ½ inch, and more particularly between 3/32 inch and 3/16 inch. The through holes 44′ can have round, square, elliptical, etc. cross-sectional profiles. In some embodiments, the through holes 44′ can be tapered (e.g., narrower or wider at the top, bottom or middle), as desired, which can enhance the functionality of the through holes 44′. As mentioned above, in some embodiments, the through holes 44′ are designed to allow for optimal flow of fluid vapors from the manifold 14′ to the substance being cooked on the grill surfaces 40′.

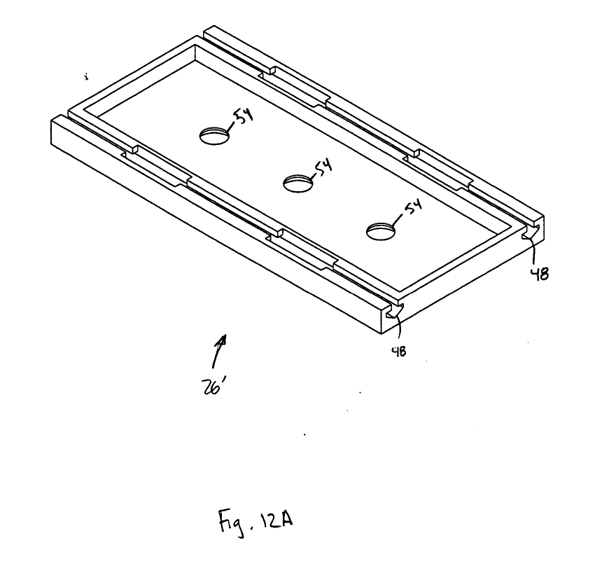

Turning now to FIG. 9, a top view of the grill base 12′ illustrates the open top portion 20′ of the grill base 12′, exposing the open interior 22′. In addition, as can be seen from FIG. 9, the grill base 12′ can include one or more recesses 34′ into which the male connectors 30′ of the manifold 14′ can be inserted. The manifold 14′ can then be manipulated so that the male connectors 30′ are displaced from the recesses 34′ into corresponding female slots 32′, to allow for secure coupling of the top platform 24′ to the base 12′.

An insert 25′, for instance, the insert 25′ illustrated in FIG. 10, can be placed into the interior 22′ of the base 12′. The insert 25′ can be used to hold heatable substances such as, for example, liquid smoke, fruit juices, alcoholic and/or non-alcoholic beverages, saturated wood chips, grease drippings, and the like. In accordance with certain embodiments of the invention, the insert 25′ can be inserted into the interior 22′ of the grill base 12′. In this way, when the grill base 12′ is heated, the insert 25′ can be heated as well and the heatable substances held by the insert 25′ likewise can be heated, perhaps producing smoke, liquid vapors, aromatic odors, and the like. In some respects, therefore, the insert 25′ can be coated with a heat resistant and/or stain resistant substance such as, merely by way of example, Teflon™, ceramic coatings, and the like. In accordance with various embodiments, the insert 25′ can be fabricated of any material capable of withstanding the temperatures typically reached in the interior 22 of the grill base 12′ and/or the temperatures generated in grills generally. Such substances can include metals, such as cast iron, stainless steel, stone, composites, terra cotta, ceramics, and the like. In certain embodiments, the insert 25′ can be fashioned so as to maximize and/or minimize thermal conductance. In particular embodiments, the insert 25′ can be used to heat additional foods, such as soup, etc. while cooking a grillable substance on the grill surfaces 40′.

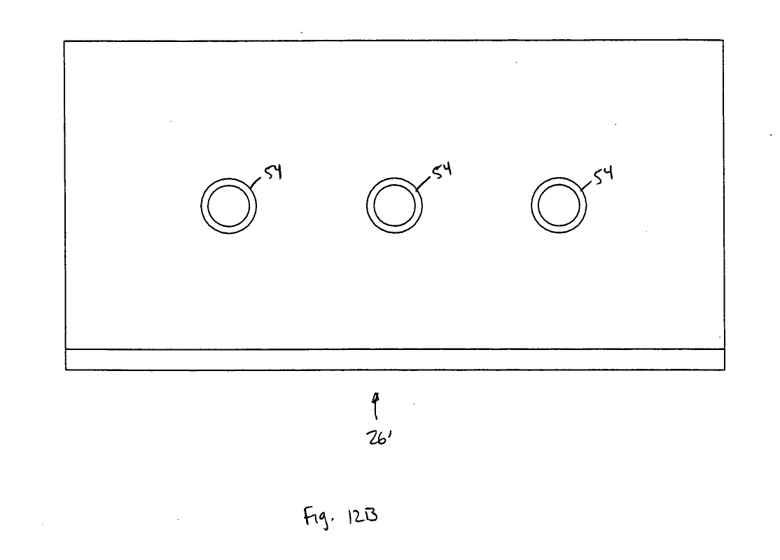

FIG. 11 illustrates an isometric drawing of a top platform 24′, which can, in some embodiments, be incorporated within a manifold 14′ such as is illustrated in FIG. 8A, for example. The top platform 24′ can be coupled to and/or sit on top of a grill base 12′. For this purpose, the top platform can include one or more male connectors 30′ that can be mated to corresponding female connectors formed within the body of the grill base 12′, as described above. The top platform 24′ can define one or more apertures 52 which can allow for the passage of heat, smoke, liquid vapors, aromatic odors, and the like, from the interior 22′ of a grill base through a conduit 28′. Thus, apertures 52′ can be formed to accept and/or be mated with conduits 28′. Merely by way of example, the apertures 52′ optionally can be threaded and/or can include some other connecting means to allow for secure connection of the conduit 28′. In certain embodiments, the top platform 24′ may be formed integrally with conduits 28′ and/or a bottom platform 26′. In such cases, the conduits 28′ may be bonded to or formed integrally with the portion of the bottom platform 24′, which defines the apertures 52′.

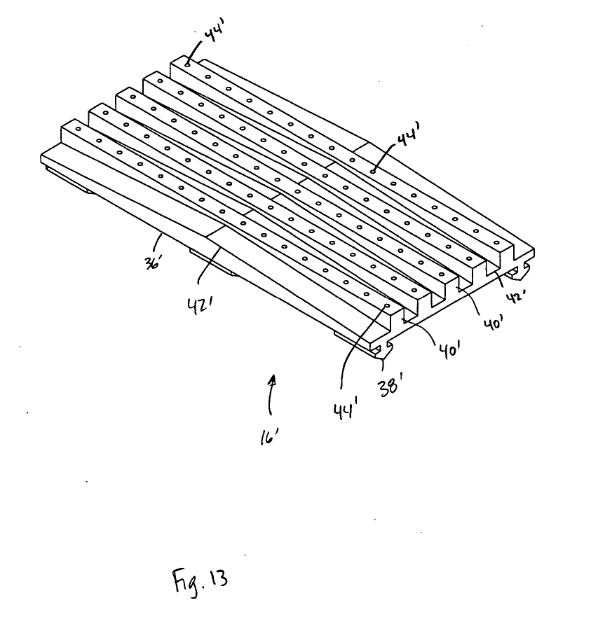

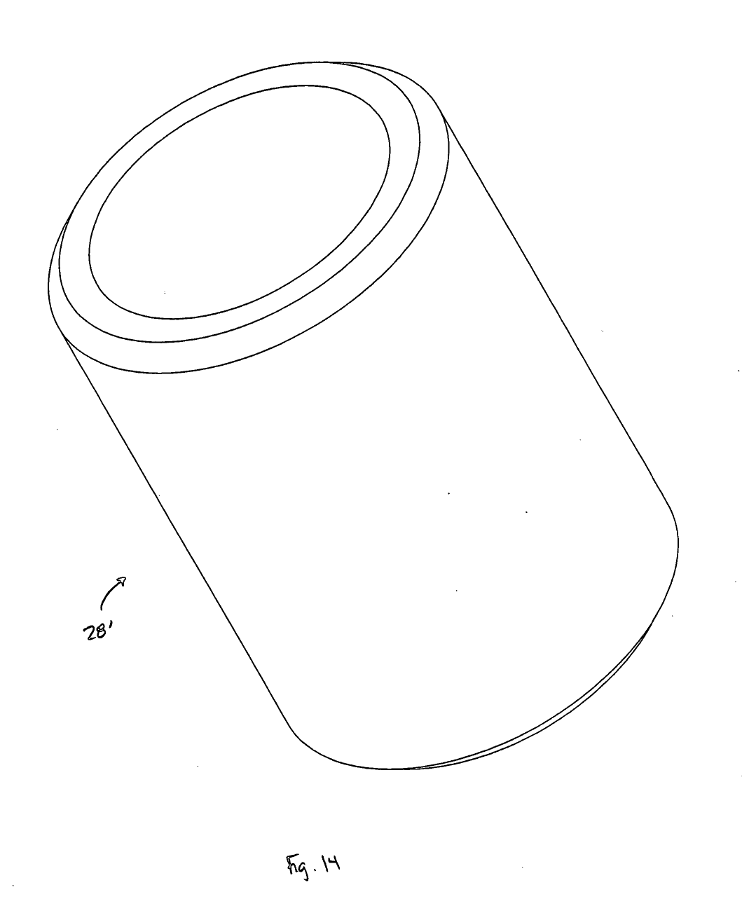

FIGS. 12A and 12B illustrate a bottom platform, which can be incorporated within a manifold 14′ in accordance with various embodiments of the invention. Bottom platform 26′ can, in some embodiments, be integrated with one or more conduits 28′ and/or a top platform 24′ to form an integrated manifold. The bottom platform 26′ can define one or more apertures 54′, which can correspond with apertures 52′ on a top platform and which can be coupled to one or more conduits 28′ for providing fluid communication between the apertures 52′ and the corresponding apertures 54′. In addition, the bottom platform 26′ can include female slots 48′, which can be configured to be coupled to a male connector 38′ on a grill member 16′. The apertures 54′ may, similar to apertures 52′, be configured to be coupled with or mated to one or more conduits 28′.

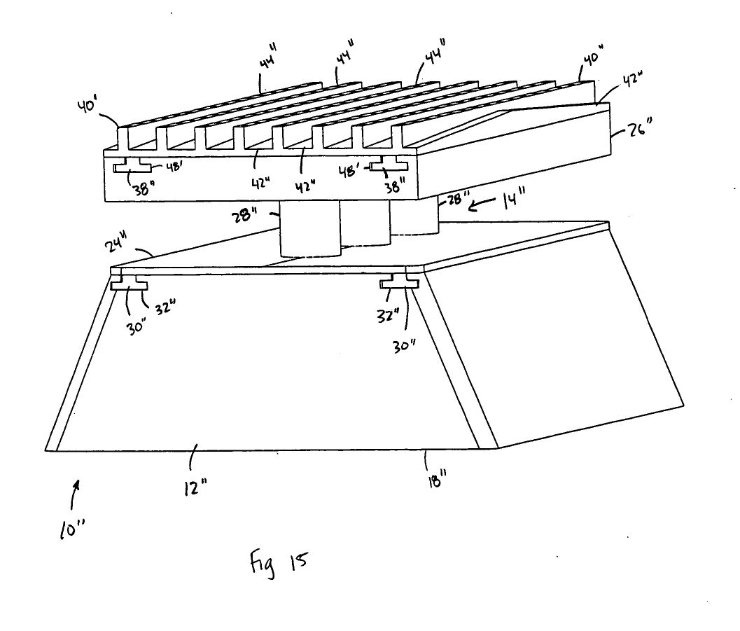

FIG. 13 illustrates a grill member 36′ that can be used in accordance with various embodiments of the invention, including, for instance, the embodiments illustrated by FIG. 8. The grill member 16′ includes one or more male connectors 38′ that can be used to, inter alia, couple a grill member 16′ to a bottom platform 26′. The grill member 16′ also can include a plurality of grill surfaces 40′ and recessed channels 42′, which can be similar to those components described above. Likewise, the grill surfaces 40′ can have a plurality of grill holes 44′ which can be configured similar to and function like those described above.

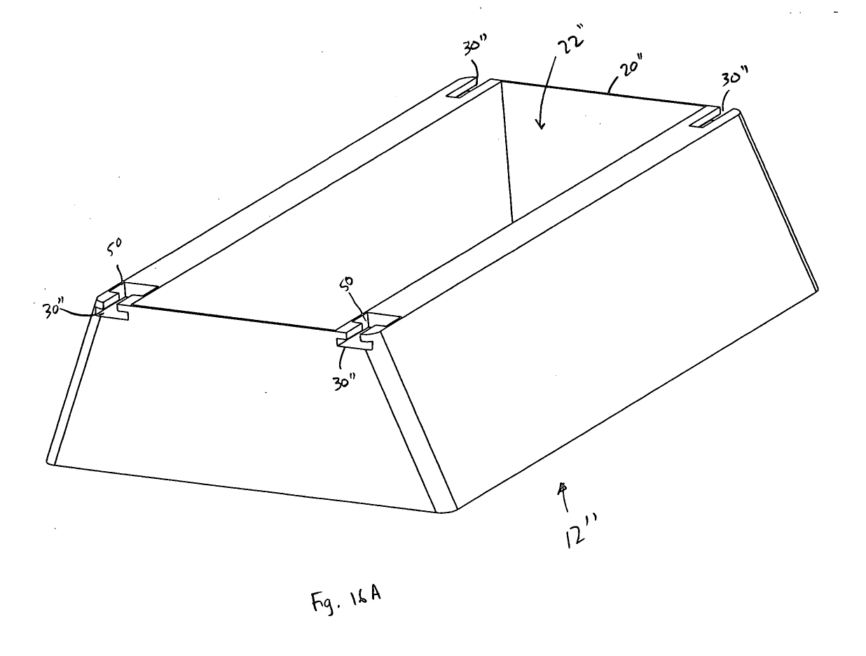

FIG. 14 illustrates a conduit 28′, which can be used as part of a manifold 14′. Depending on the embodiment, the conduit 28′ can have any of a variety of cross-sectional profiles and/or areas. In some embodiments, for example, conduits 28′ can have a circular cross-sectional profile, and, in others, the cross-sectional profile might be, for instance, elliptical, octagonal, square, etc. In certain aspects, the conduits 28′ can include features to allow for coupling with a top platform 24′ and/or a bottom platform 26′. In accordance with certain embodiments of the invention, the diameter and/or cross-sectional area of a conduit 28′ can correspond to a similar diameter and/or cross-sectional area of an aperture 52′ or 54′. In particular embodiments, the cross section of the conduits 28 is round, with a diameter of about ⅛ inch to about two inches. In other embodiments, the conduits 28′ have a diameter of about ¾ inch to about 1¼ inches.

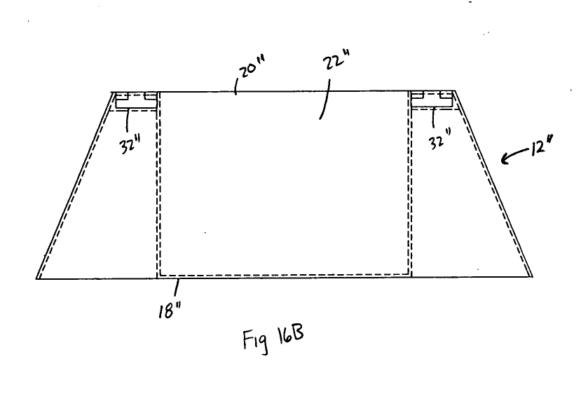

FIGS. 15-19 illustrate components of a grilling system 10″ in accordance with further embodiments of the invention. The grilling system 10 ″ can include a grill base 12″ defining an open interior 22 ″, accessible, inter alia, through an open top portion 20″. The grill base 12″ can be removably coupled to a manifold 14″ comprising a top platform 24″, a bottom platform 26″ and one or more conduits 28″ therebetween, similar to those components described above. The manifold 14″ can also be coupled to a grill member 16″ having grill surfaces 40″ and recessed channels 42″. The grill surfaces 40″ can have a plurality of holes 44″, similar to those described above.

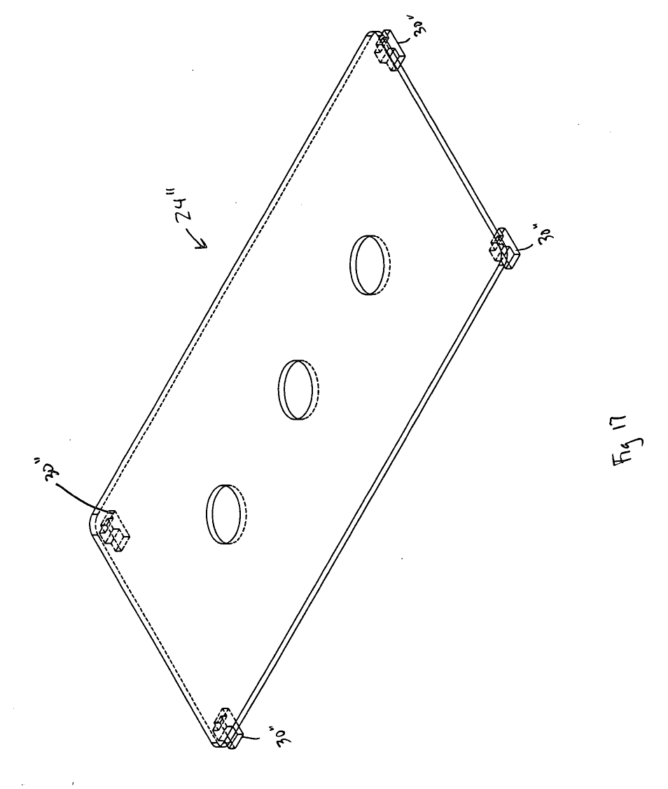

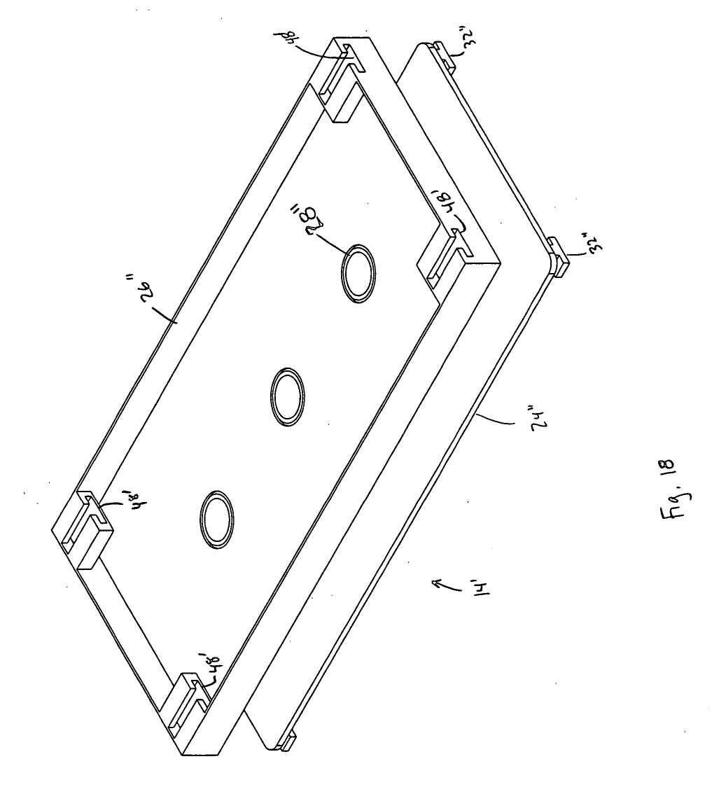

The embodiments illustrated by FIGS. 15-19 can have coupling devices similar to those described above. In some embodiments, the top platform 24″ can have male connectors 32″, which can be configured to mate with female slots 30″ in the grill base 12″. In some aspects, for instance as illustrated on FIG. 16A, 16B and 17, the slots 32″ can be designed to allow movement of the top platform 24″ in only one direction relative to the base 12″. In operation, the male connectors 30″ near one end of the top platform 24″ can be placed into recesses 50 on one portion of the base 12″ (with the connectors 30″ near the other end of the platform 24″ placed adjacent to the base 12″), and the top platform 24″ can be moved relative to the base 12″ such that the connectors 30″ are positioned within the slots 32″. In this way, the top platform 24″ can be coupled securely to the base 12″.

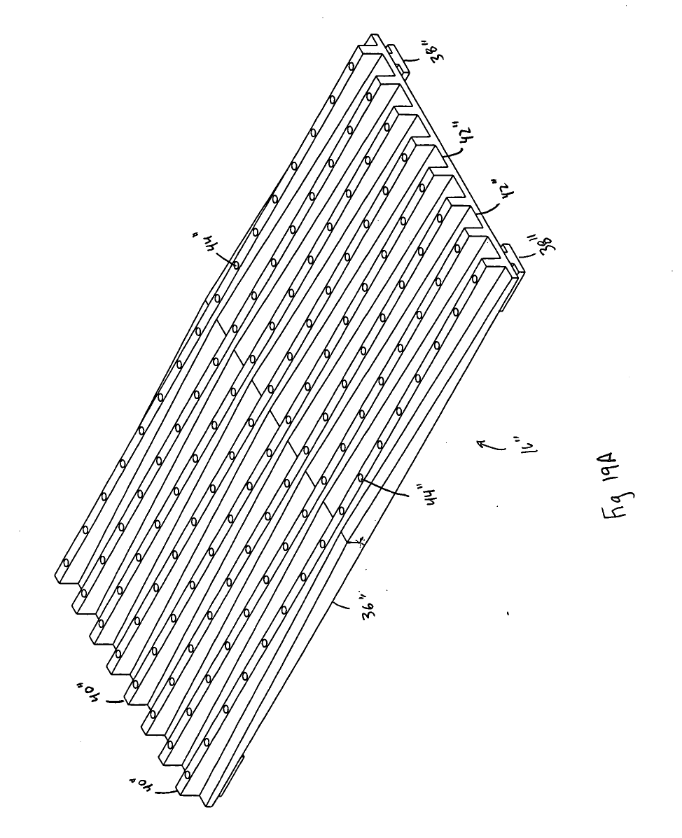

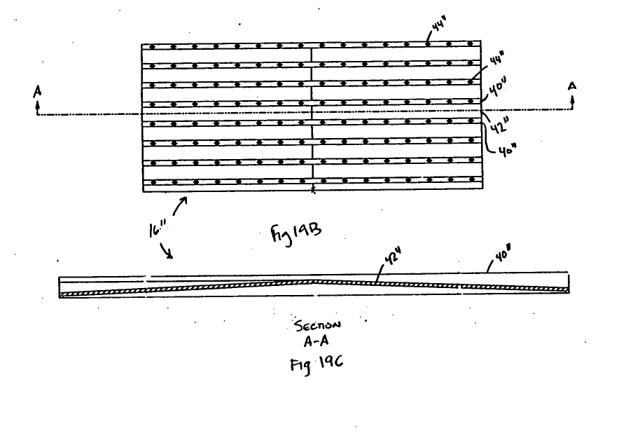

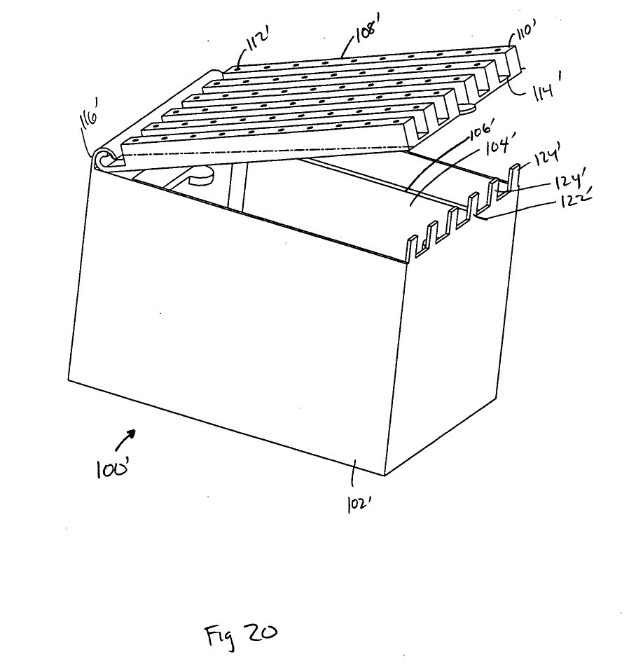

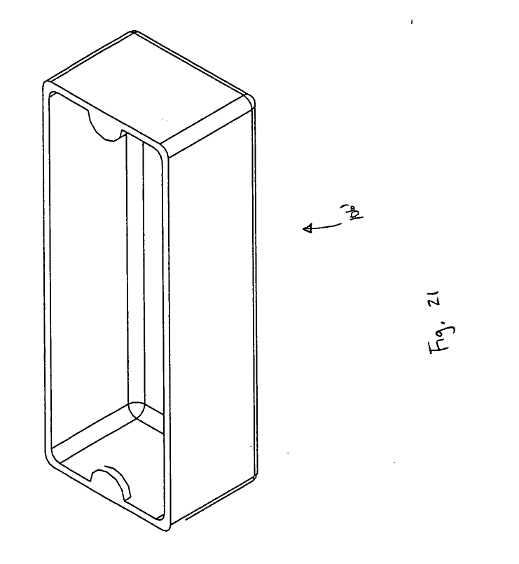

FIG. 18 illustrates a manifold 14″, which can be an integrally formed member and/or can comprise separate components as discussed above, including a top platform 24″, conduits 28″ and a bottom platform 26″. The bottom platform 26″ can include female slots 48 ″, which can be adapted to accept male connectors 38″ on a grill member 16″, such as is illustrated on FIG. 19A. Similar to the slots 32″ discussed with respect to FIGS. 16A, 16B and 17, the slots 48′ can be designed to allow movement of the grill member 16″ in only one direction with respect to the bottom platform 26″. As shown in FIGS. 19B and 19C, the grill member 16″ can have recessed channels 42″ situated between grilling surfaces 40″, and the recessed channels 42″ can have an apex, which can be coplanar with and/or slightly lower than the grill surfaces 40″.

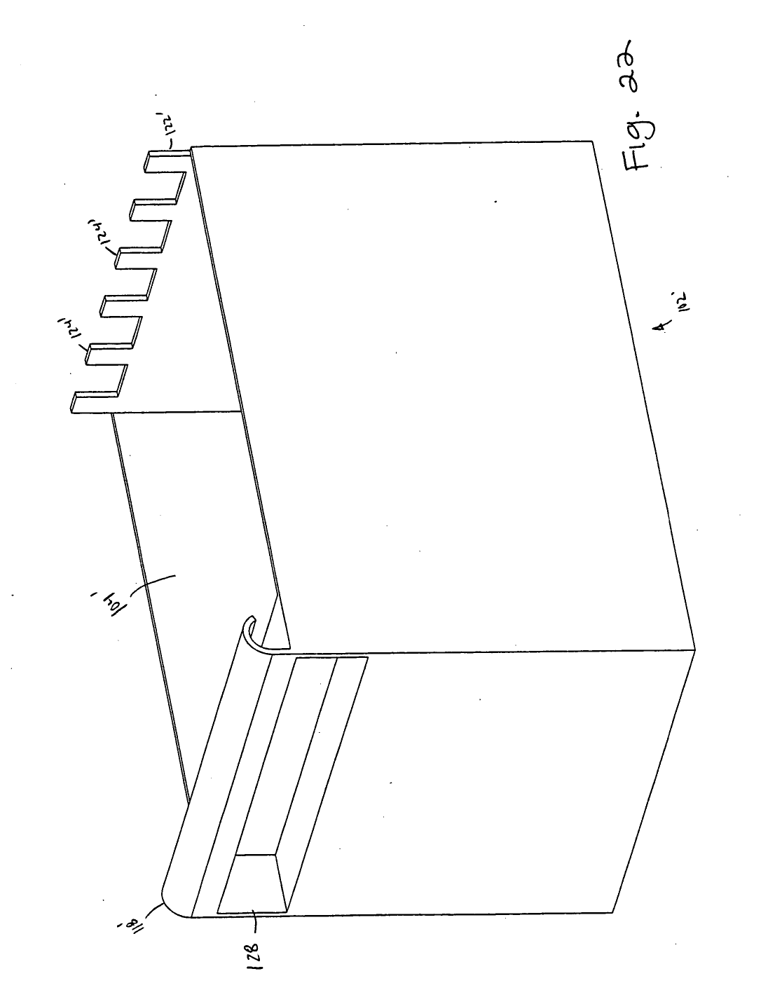

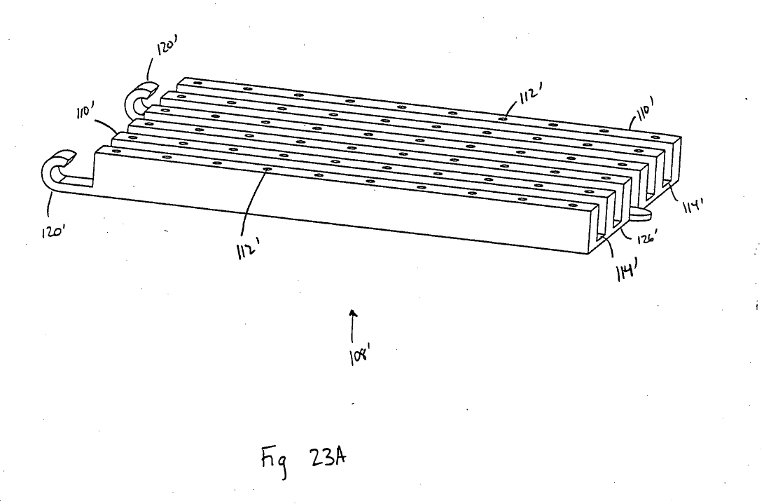

FIGS. 20-23 illustrate a grilling system 100′ in accordance with various embodiments of the invention. In some aspects, the grilling system 100′ can be relatively portable and therefore can be configured to be of appropriate size to be transported easily between various locations. Those skilled in the art will recognize, however, that other embodiments can be configured similarly to the illustrated grilling system 100′ and yet can be larger and/or be intended for more permanent installation in a given location. The grilling system 100′ has a grill base 102′ that can define an open interior 104′, which optionally can be configured to hold a removable insert 106′, such as the insert 106′ illustrated in FIG. 21. The insert 106′ can be similar to those described above.

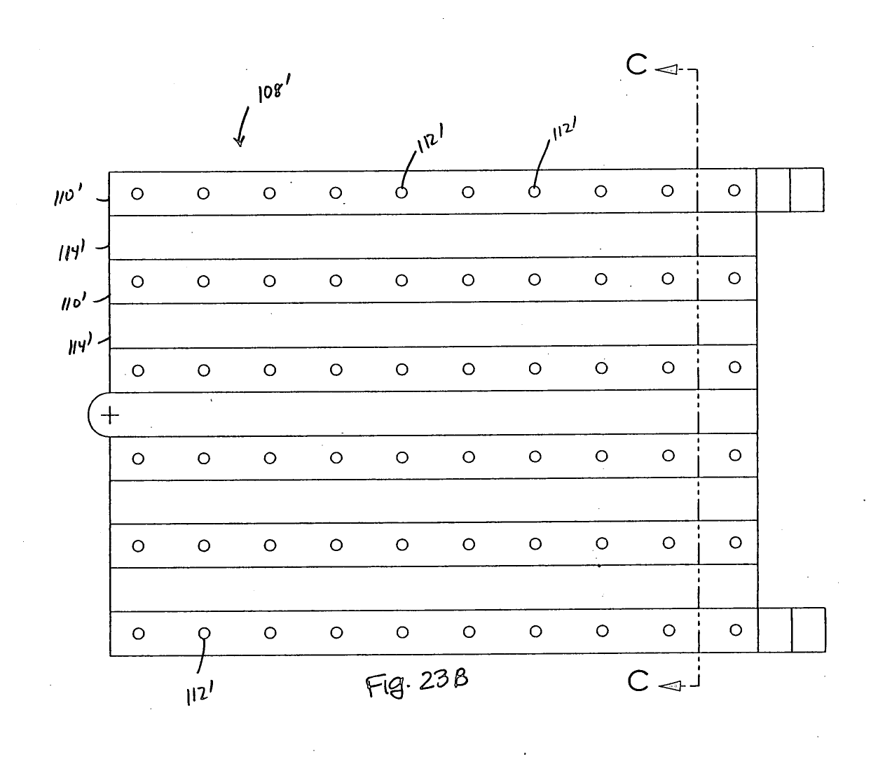

1As illustrated on FIG. 22, the grill base can define one or more handling facilities, such as depression 128, which can allow the grilling system 100 easily to be transported. In accordance with some embodiments, the handling facilities can be coated with and/or fabricated from an insulating material, to allow for more comfortable handling. The insulating material can be removable and/or can be designed to withstand typical grilling temperatures, to prevent damage to the handling facilities during operation.

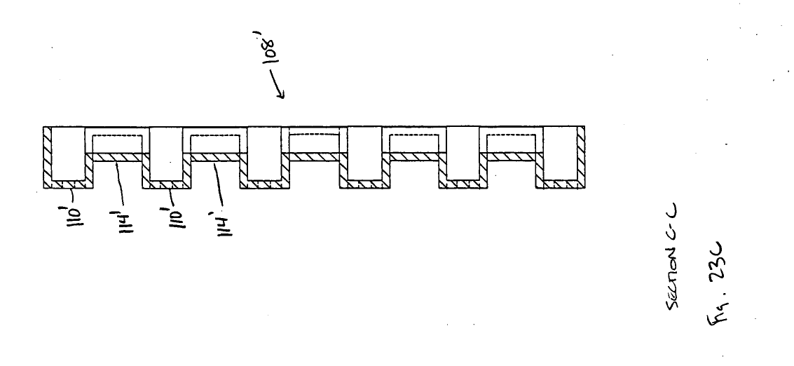

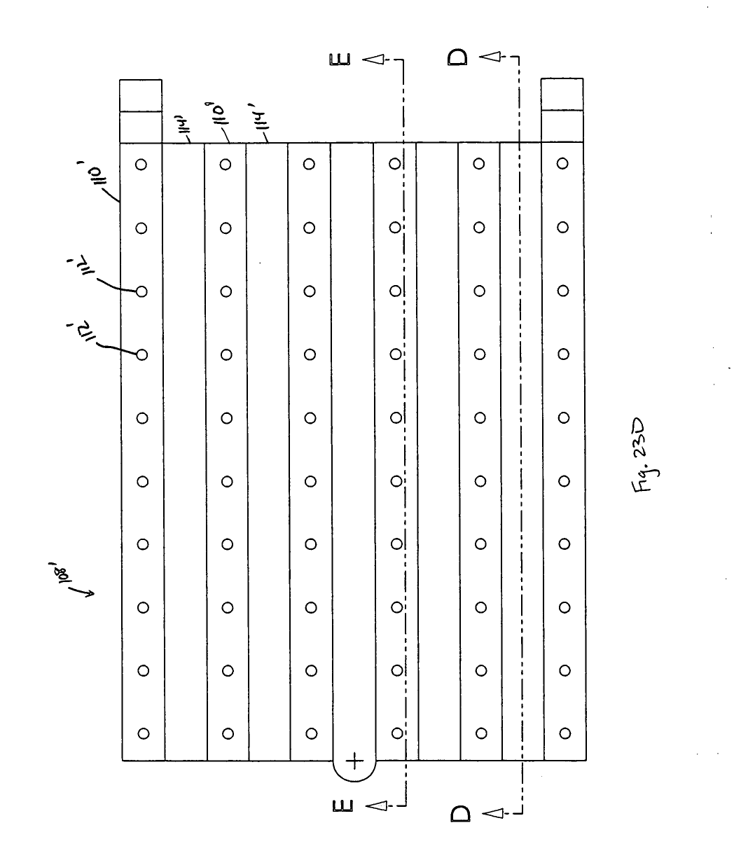

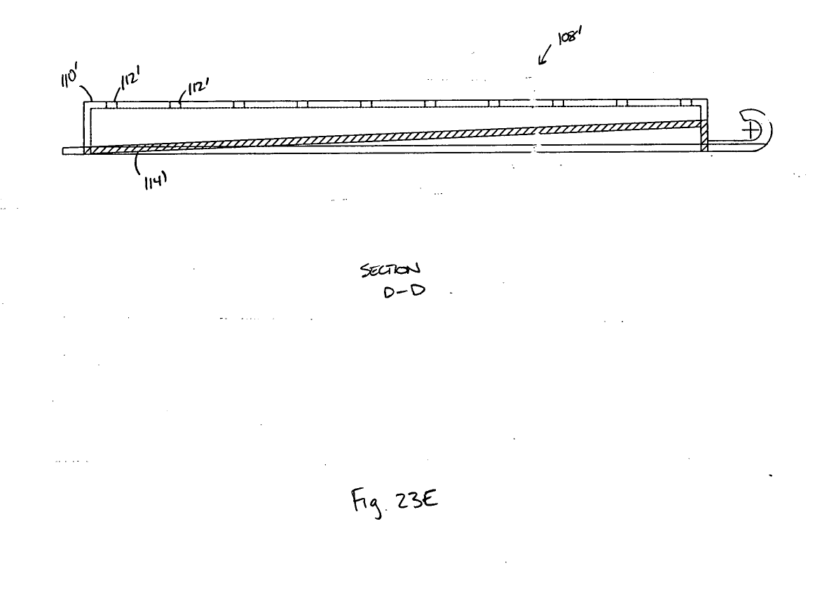

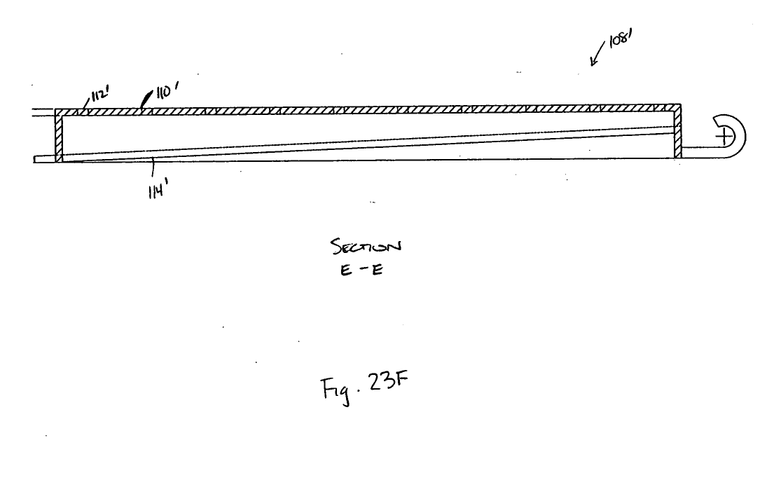

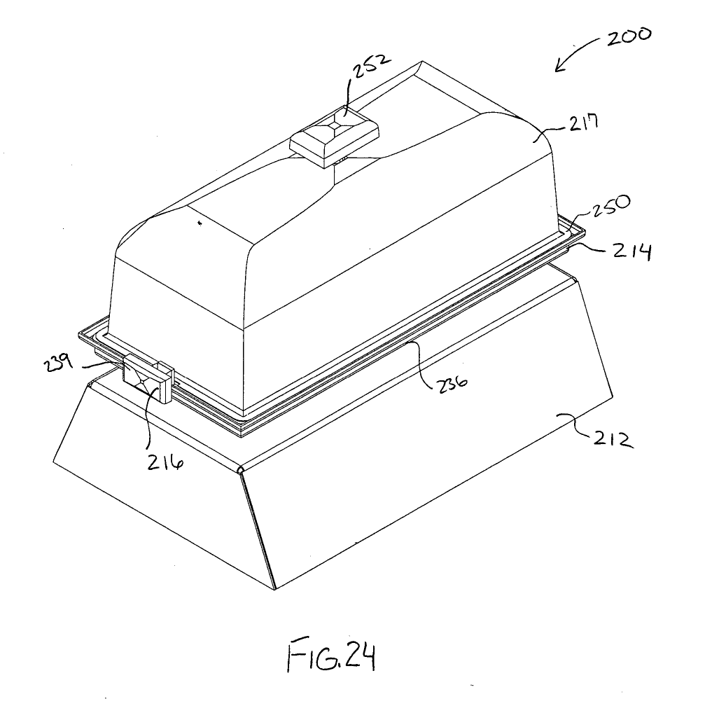

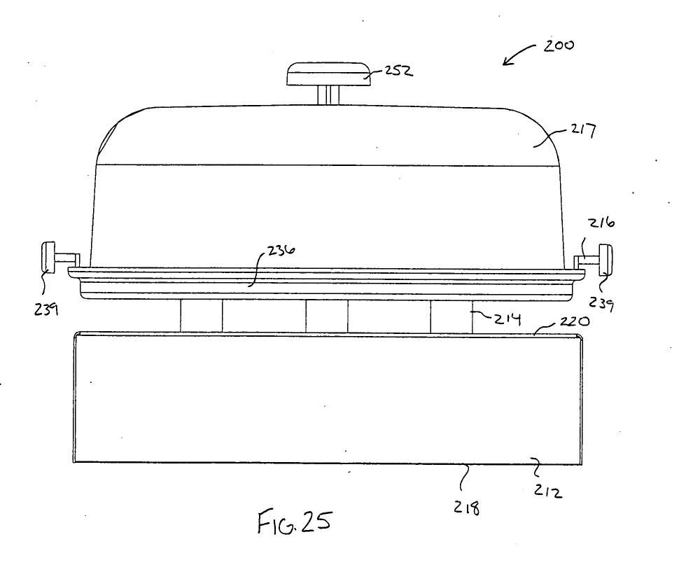

Coupled to the grill base 102′ can be a grill member 108′. The grilling system 100′ can include one or more attachment members 116′, such as hinges or the like, to allow for the coupling of the grill member 108′ to the base 102′. As illustrated on FIGS. 22 and 23A, in accordance with some embodiments, the attachment member 116′ can comprise opposing and/or interlocking members 118′, 120′, which can allow the grill member 108′ to be rotatably attached at one end to the grill base 102′. Thus, the grill base 108′ can be rotated about the attachment member 116′ to allow access to the interior 104′ of the grill base 102′.

The grill member 108′ can have a plurality of raised grill surfaces 110′ defining a plurality of through holes 112′, which can be similar in configuration and/or function to the holes (e.g., 44) described with respect to other embodiments. As illustrated by FIGS. 23A-23F, one or more recessed channels 114′ can be situated between grill surfaces 110′. The recessed channels 114′ can be configured with slope in order to allow liquids to drain off of the surface of the grill member 108′, as discussed previously.

The grilling system 100′ can further feature an additional attachment mechanism located opposite to the attachment member 116′, which can be used, inter alia, prevent unintended separation of the grill member 108′ from the grill base 102′ such as during transport, etc. For example, the base 102′ may include a male locking member 122′ having a plurality of teeth 124′. The locking member 124′ can be configured to mate with a female locking member 126′ on the grill member 108′. When the grill member 108′ rests upon the base 102′, the teeth 124′ extend up into grill member 108′ to contact the bottom of the grill surfaces 110 ′ while the bottom of the channels 114 ′ rest in the regions between the teeth 124′ to interlock the two components.

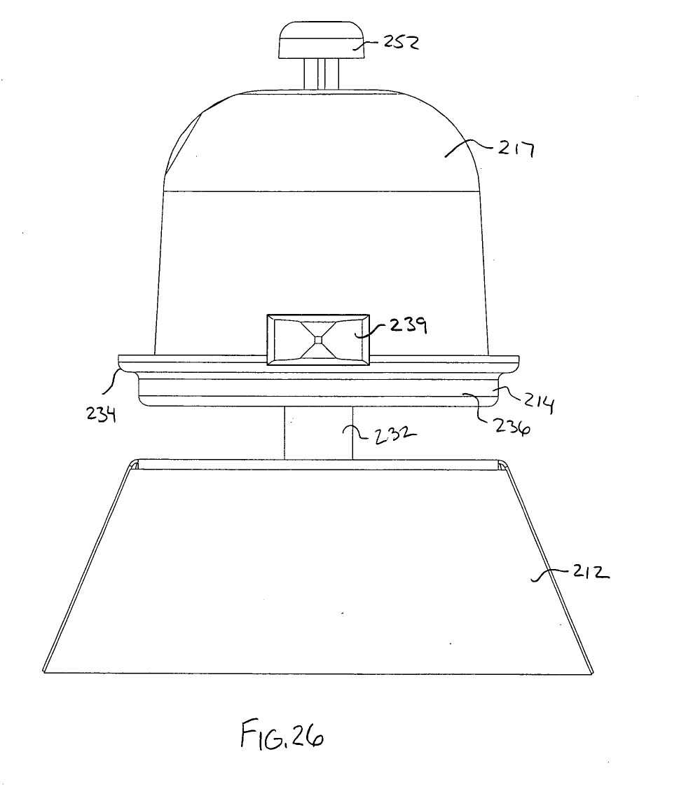

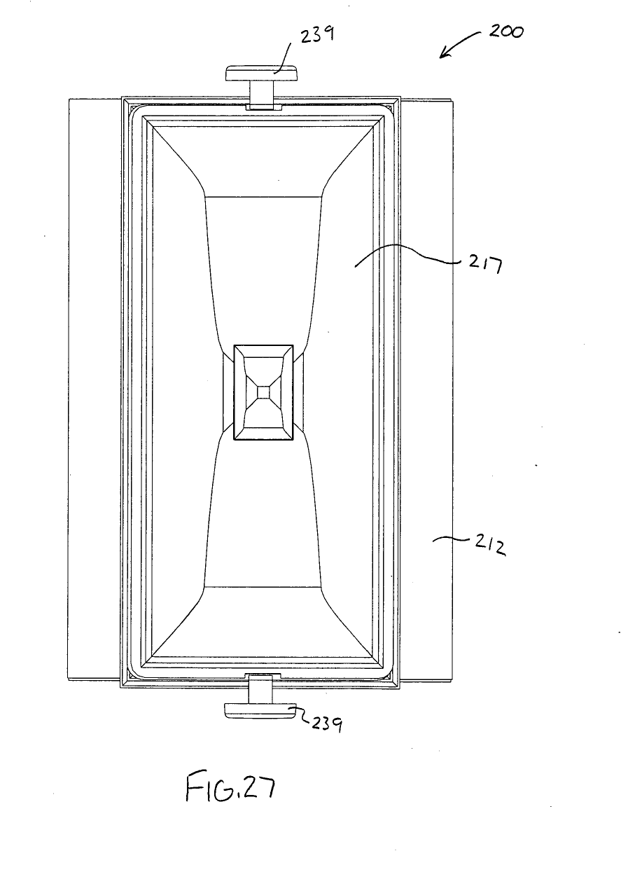

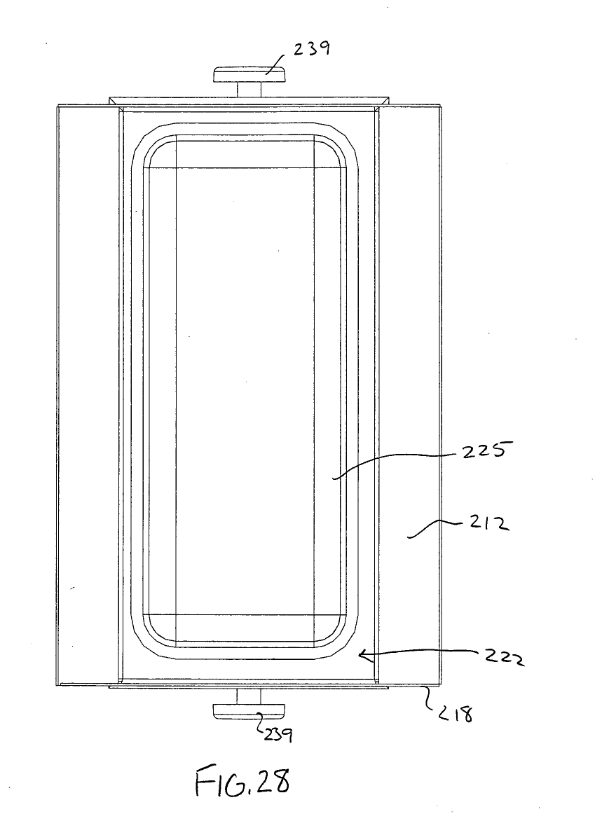

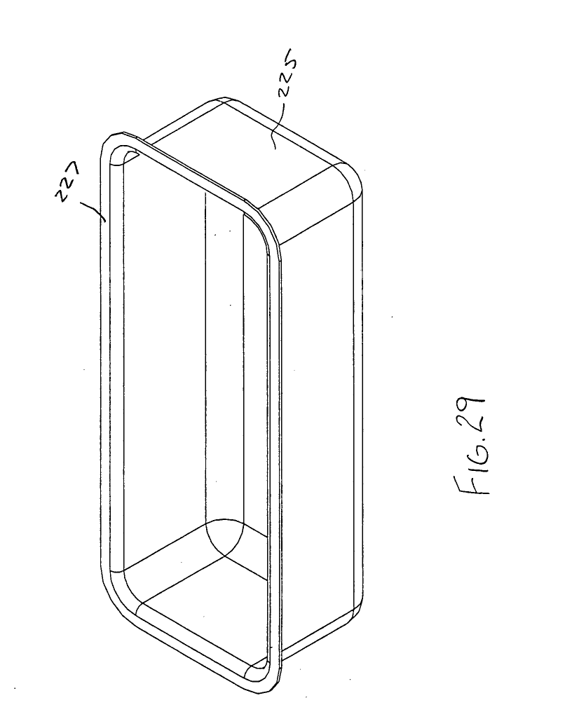

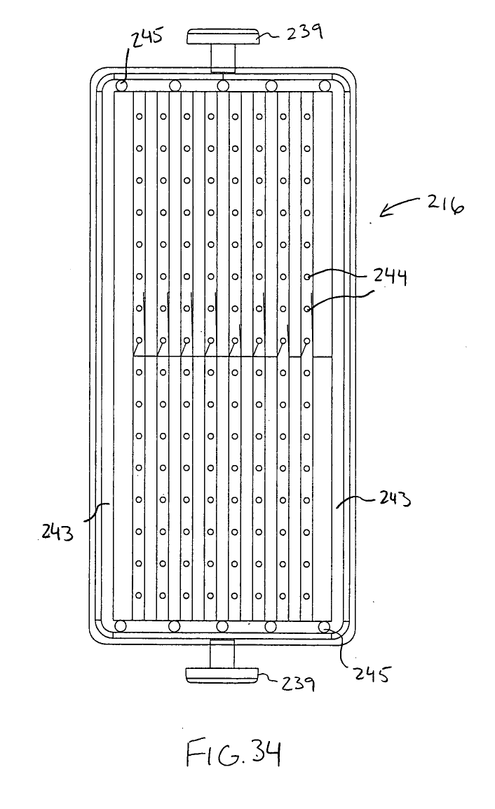

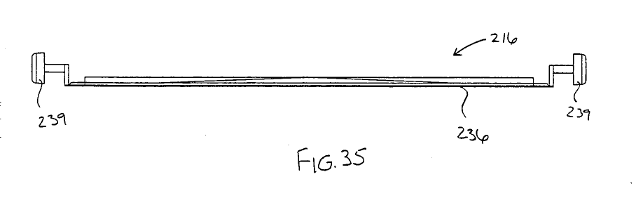

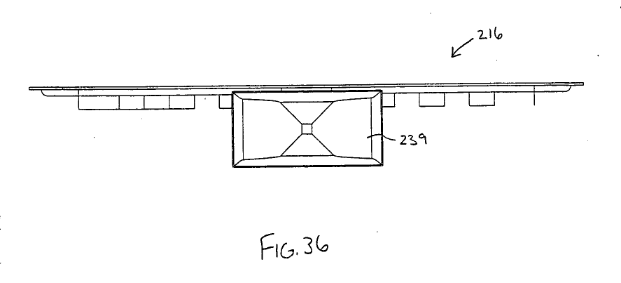

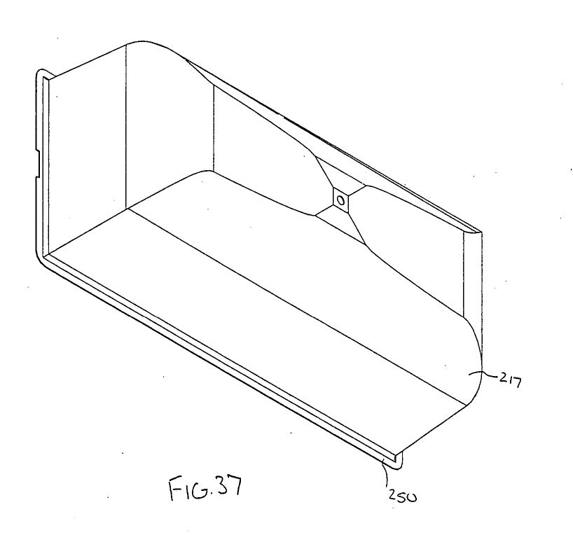

FIGS. 24-37 illustrate another embodiment of a grilling system 200. Grilling system 200 comprises a grill base 212, a manifold 214, a grill member 216 and a cover 217. Grill base 212 has an open bottom end 218, a top end 220 and an interior 222 (see FIGS. 28 and 31) that is accessible from the bottom end 218. Bottom end 218 is configured to rest on essentially any type of heated surface, such as a conventional grill, a heating element, or the like. Grill base 212 is preferably constructed of a thermally conductive material, such as metal, stainless steel, aluminum, or the like to efficiently transfer heat to grill member 216. 106The interior 222 of grill base 212 may be used to hold a substance that may be heated to produce smoke and/or liquid vapors that rise up into manifold 214. Such substances may comprise those that produce smoke, such as wood chips, as well as various types of liquids that produce steam when heated. The size of the interior may be varied depending on the substance used. Grill base 212 may be constructed to be small enough that it takes up only part of the grill upon which it rests. In this way, other food items may be grilled in the traditional manner on the grill while the grill is used to supply heat to the grill base 212.

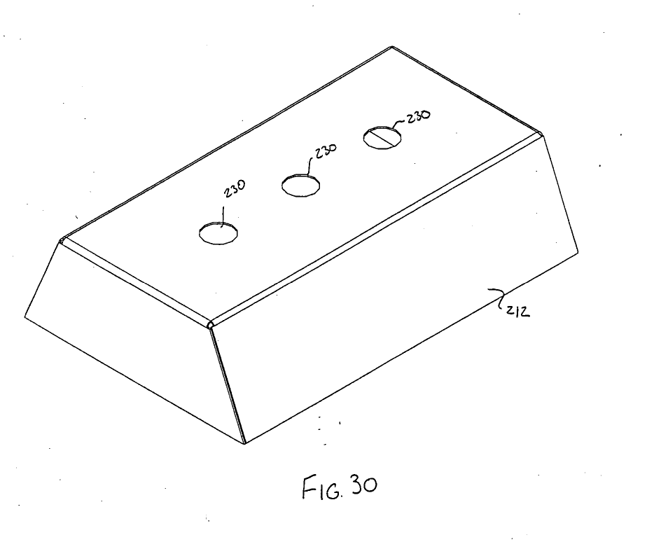

Optionally, an insert 225 (see FIGS. 28 and 29) may be held within interior 222 to hold a liquid or other substances that are to be heated. Insert 225 may comprise essentially any type of open vessel that is capable of holding a liquid and that can withstand the grilling temperatures. Examples of materials that may be used include ceramics, metals, stainless steel, composites, and the like. One advantage of using insert 225 is that it may easily be removed for cleaning. Insert 225 may be configured so that its top end 227 almost touches or is within about ½ inch of top end 220 of base 212. This maximizes the amount of fluid that insert 225 may hold.

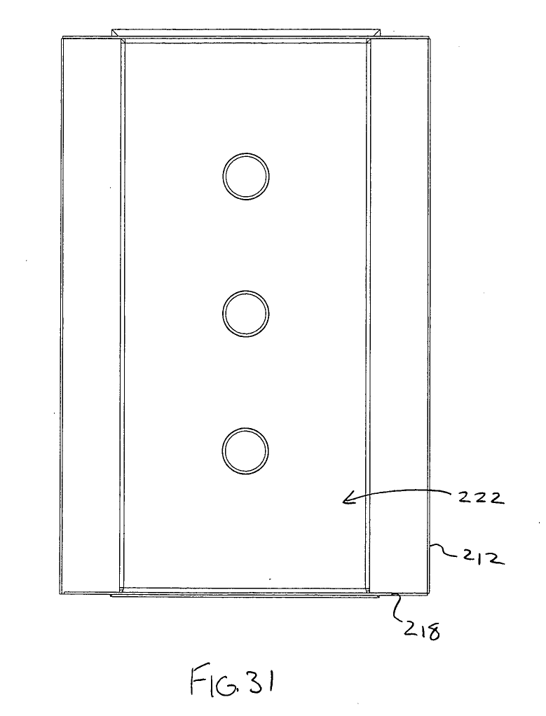

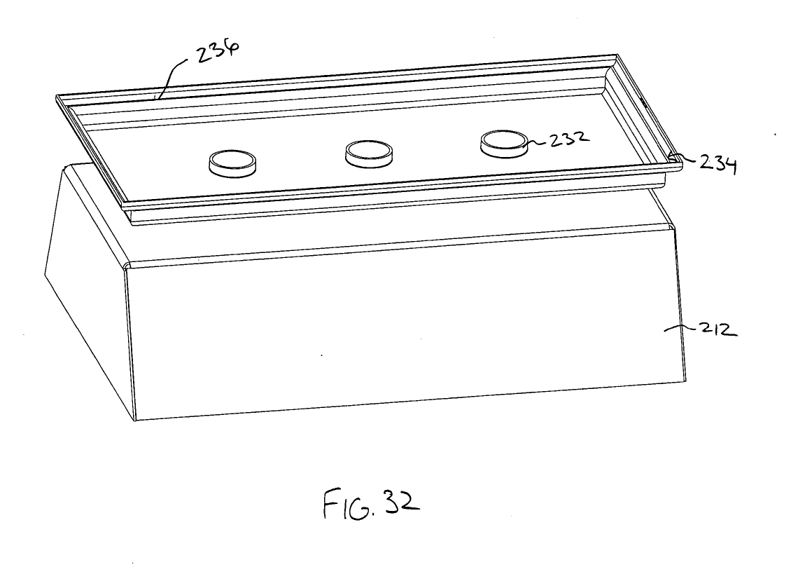

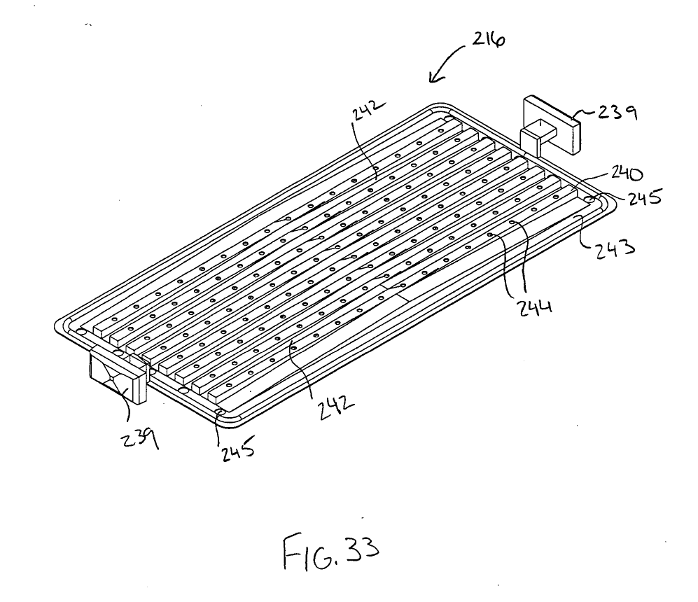

Base 212 includes a set of holes 230 (see FIG. 30) into which are secured a set of conduits 232. Although shown with three conduits, it will be appreciated that other numbers may be used as well. Along with a platform 234 (see FIG. 32), conduits 232 form manifold 214. To reduce the profile of grilling system 200 as well as manufacturing costs, conduits 232 may be welded to base 212. Conduits 232 may be constructed of a thermally conductive material similar to other embodiments. The other end of conduits 232 extend through openings in platform 234 and may be welded to platform 234 as well. Platform 234 provides a convenient way to hold grill member 216 as well as to distribute the smoke and/or vapors in a manner similar to other embodiments. As described herein, platform 234 may also be used to catch grease or other liquids from grill member 234. To facilitate holding of grill member 216, platform 234 may include a ledge 236 that extends around the periphery of platform 234 to hold the grill member 234. In this way, grill member 234 may easily be removed simply by lifting it off ledge 236.

As best shown in FIGS. 33-36, grill member 216 may be constructed of a single piece of a grill material, such as metal, and may easily be removed from platform 236 using handles 239. For convenience of manufacture, handles 239 may be constructed of the same material used to make grill member 216. However, in some cases, an insulator may also be used, such as wood, plastic or rubber. Grill member 216 includes a plurality of raised grill surfaces 240 that are generally parallel to and spaced apart from each other, although different configurations and orientations may be used as well. Grill surfaces 240 are designed to hold the substance being grilled. When grilling system 200 is placed onto a grill or otherwise heated, heat from base 212 is transferred through the device and up to grill surface which becomes hot enough to grill the substance resting on grill surfaces 240 similar to that described with other embodiments.

Positioned between grill surfaces 240 are a plurality of recessed channels 242. Channels 242 slope downward from an apex that is in the middle of grill member 216. In this way, greases or other liquids from the item being grilled flow down the channels and away from grill surfaces 240. When these liquids reach the edge of grill member 216, they flow into a channel 243 that extends around the other edge of grill member 216. Formed in channel 243 are a plurality of drain holes 245 though which liquids drain into platform 234. In this way, greases or other undesirable substances produced from the item being grilled are drained into platform 234 to produce a healthier food product. By collecting liquids in platform 234, they do not drain on the outside of grill system 200. As such, grill system 200 may be used for indoor grilling as well. Conduits 232 may extend up into platform 234 to prevent liquids from draining down conduits 232 and into base 212. Although drain holes 245 are shown at ends of grill member 216, it will be appreciated that they may be positioned anywhere along channel 243.

Extending through grill surfaces 240 are a plurality of through holes 244 that completely pass through grill member 216. In this way, smoke and/or vapors rising up from interior 222 pass through conduits 228 and into the cavity defined by platform 234. Here, the smoke and/or vapors are distributed across bottom 236 of grill member 216 and pass up through holes 244. As the smoke and/or vapors pass upwardly through holes 244, they come into contact with the items on grill surfaces 240 similar to other embodiments. Depending on the type of smoke and/or steam, the items being grilled may be flavored, moistened and/or further cooked. Hence, the items being grilled may be smoked and/or steamed while simultaneously being grilled. Such a system may therefore be used to flavor the items without requiring them to continually be basted. Further, the items may be provided with a moist delicate flavor because they are moistened while being cooked, even if cooked to the point of being well done. As such, meats may be well cooked to eliminate bacteria or disease while still being moist and delicate.

The number and/or size of holes 244 may be varied depending upon a variety of factors, including the type of item being grilled, the substance used to produce the smoke and/or steam, the amount of flavoring required and the like, similar to other embodiments.

Lid 217 is sized large enough to completely cover grill member 216 (except for handles 239). Lid 217 may come in a variety of sizes depending on the substances being grilled. For example, lid 217 may be taller or shorter depending on what is being cooked. Lid 217 includes a lip 250 that fits within platform 236 as best shown in FIG. 24. Lid 217 functions to completely enclose the item being cooked. In this way, cooking temperatures may be increased, and steam and smoke are captured and kept around the item being grilled. Lid 217 may be constructed of a wide variety of materials, such as stainless steel, aluminum, composites and the like.

Conveniently, a handle 252 maybe coupled to lid 217 to provide an easy way to move lid 252. Handle 252 is shown on top of lid 217, although it will be appreciated that handles may be placed on other locations as well. Handle 252 may be constructed of a metal, stainless steel, or the like, or out of an insulation.

The invention has now been described in detail for purposes of clarity and understanding. However, it will be appreciated that certain changes and modifications may be practiced within the scope of the appended claims.

What is claimed is:

1. A grilling system, comprising:
a grill base that is adapted to be heated, wherein the grill base has a top end, an open bottom end, and an open interior that is adapted to hold a heatable substance that produces smoke or liquid vapors when heated, the top end defining at least one opening, thereby exposing the open interior;
an insert that is configured to be held within the interior of the grill base, and wherein the insert is configured to hold the heatable substance
a manifold coupled to the grill base so as to be positioned above the heatable substance, the manifold comprising at least one conduit;
a grill member positioned above the manifold, wherein the grill member comprises a plurality of grill surfaces that each have a plurality of holes and a plurality of downwardly angled fluid removal channels interleaved between the grill surfaces, wherein the grill surfaces are configured to receive a grillable substance, whereby smoke or liquid vapors rising from the grill base pass through the at least one conduit and then through the holes.

2. A grilling system as in claim 1, wherein the grill base and the insert comprise a thermally conductive material.

3. A grilling system as in claim 1, wherein the manifold comprises a thermally conductive material, and wherein the grill surfaces comprises a grill material.

4. A grilling system as in claim 1, wherein the manifold further comprises a platform that is adapted to removably hold the grill member.

5. A grilling system as in claim 4, wherein the platform includes a lip, and wherein the grill member is configured to rest on the lip.

6. A grilling system as in claim 4, wherein the grill member includes a fluid collection channel for collecting liquids, and at least one drain through which the liquids may drain from the grill member and into the platform.

7. A grilling system as in claim 1, further comprising a lid that is adapted to be placed over the grill member.

8. A method for grilling a grillable substance, the method comprising:
providing a grill base having a top end, an open bottom end, and an open interior;
placing a heatable substance into the interior through the open bottom end;
placing a grill member above the grill base, wherein the grill member comprises at least one grill surface having a plurality of holes;
placing at least one grillable substance onto the grill surface;
heating the grill base to cause heat to be transferred to the grill surface to grill the grillable substance and to produce smoke or liquid vapors from the heatable substance, wherein the smoke or liquid vapors rise from the grill base and pass through the holes in the grill surface.

9. A method as in claim 8, further comprising coupling a manifold between the grill base and the grill member so as to be positioned above the heatable substance and below the grill surface, the manifold comprising at least one conduit configured to provide fluid communication between the open interior of the grill base and the grill surface to permit smoke or liquid vapors to reach the grill surface.

10. A method as in claim 8, further comprising placing a lid over the grill surface.

11. A method as in claim 8, further comprising placing the grill base onto a barbecue grill to provide the heat to the grill base.

12. A method as in claim 8, wherein the heatable substance comprises moist wood chips that are placed into the interior.

13. A method as in claim 8, wherein the heatable substance comprises a liquid, and further comprising pouring the liquid into an insert, and placing the insert into the interior.

14. A method as in claim 9, further comprising removing the grill member from the manifold, and washing the grill member.

15. A method as in claim 9, further comprising collecting liquid in a channel formed in the grill member and draining the liquid into the manifold.

16. A grilling system, comprising:
a grill base that is adapted to be heated, wherein the grill base has a top end, an open bottom end, and an open interior that is adapted to hold a heatable substance that produces smoke or liquid vapors when heated, the top end defining an opening, thereby exposing the open interior;
a grill member positioned above the grill base and removably coupled thereto, such that the grill member at least partially covers the open top end of the grill base, wherein the grill member comprises a plurality of grill surfaces that each have a plurality of holes and a plurality of sloping channels between the grill surfaces, wherein the grill surfaces are configured to receive a grillable substance, such that smoke or liquid vapors rising from the grill base pass through the holes in the grill surfaces.

17. The grilling system of claim 16, wherein the grill base comprises a rotational coupling apparatus and the grill member comprises a corresponding rotational coupling apparatus, such that when the grill member is coupled to the grill base, that the grill member may be rotated about an axis roughly defined by the rotational coupling apparatus of the grill base to allow access to the open interior.

18. The grilling system of claim 16, wherein each of the holes in the grill surface has a circular cross-sectional profile and a cross-sectional diameter of about one-sixteenth inch to about one-half inch.

19. A grilling system, comprising:
a grill base that is adapted to be heated, wherein the grill base has a top end, a bottom end, and an open interior that is adapted to hold a heatable substance that produces smoke or liquid vapors when heated;
a grill member positioned generally above the grill base, wherein the grill member comprises at least one grill surface having a plurality of holes, wherein the grill surface is configured to receive a grillable substance,
a manifold coupled to the grill base and the grill member and positioned therebetween, the manifold comprising at least one conduit configured to provide fluid communication between the grill base and the grill member, such that smoke or liquid vapors rising from the open interior of the grill base pass through the conduit and then through the holes in the grill surface.

20. The grilling system of claim 19, wherein the conduit has a circular cross-sectional profile, and wherein the conduit has a cross-sectional diameter of about one-half inch to about two inches.

21. The grilling system of claim 19, wherein each of the holes in the grill surface has a circular cross-sectional profile, and wherein each of the holes has a cross-sectional diameter of about one-sixteenth inch to about one-half inch.
